(19) United States
(12) Patent Application Publication
(10) Pub. No.: US 2024/0317336 A1
(43) Pub. Date: Sep. 26, 2024

(54) CRATER OBSERVING BIO-INSPIRED ROLLING ARTICULATOR

(71) Applicant: Northeastern University, Boston, MA (US)

(72) Inventors: Alireza Ramezani, Bridgewater, MA (US); Matthew Schroeter, Pasadena, CA (US); Ian McCarthy, Westford, MA (US); Adarsh Salagame, Boston, MA (US)

(21) Appl. No.: 18/606,771

(22) Filed: Mar. 15, 2024

Related U.S. Application Data
(60) Provisional application No. 63/490,904, filed on Mar. 17, 2023.

(51) Int. Cl. B62D 57/02; B64G 1/00

(52) U.S. Cl. CPC B62D 57/02; B64G 1/00

(57) ABSTRACT

A robot comprises a body comprising a scalable joint module having a housing including an actuator within the housing powered by a voltage regulator on the housing and defining a female connector cavity of the housing; a first plurality of axial thrust roller bearings on the housing and a second plurality of axial thrust roller bearings on an opposite side of the housing, wherein each of the first and second plurality of axial thrust roller bearings are sandwiched between two washers; a male connector opposite from the female connector cavity; a head module coupled to the body, containing an onboard computing system controlling the movement of the lunar exploration robot, and an actuated latching mechanism; and a tail module coupled to the body, wherein the tail module defines a cavity configured for the actuated latching mechanism of the head module to enter, to thereby couple the head and tail modules.

### RELATED APPLICATION(S)

This application claims priority to U.S. Provisional Application No. 63/490,904, filed Mar. 17, 2023, which is incorporated herein by reference in its entirety.

### GOVERNMENT SUPPORT

This invention was made with government support under Grant Number 80NSSC20M0048 awarded by NASA. The government has certain rights in the invention.

### BACKGROUND

Craters on the Moon, such as Shackleton Crater, are of particular interest due to the presence of water ice inside them confirmed using satellite imaging. Numerous products can be produced on the moon using water, such as rocket propellant, and it can be used to enable long term habitation on the moon. However, the exact location and quantity of the water is unknown and precursor robotic explorers are needed to search for water.

Existing mobility systems are insufficient to traverse these craters due to the extreme mobility challenges. In Shackleton Crater there is high porosity lunar regolith, steep slopes (30.5-degree average slopes, maximum 35 degrees), large distances to travel (20 kilometers in diameter), limited sunlight and cryogenic temperatures. State of the art wheeled rovers such as NASA's Volatiles Investigating Polar Exploration Rover (VIPER) can traverse a maximum of 30-degree slopes as it relies on adequate traction and is prone to slippage and sinkage in the porous lunar regolith. Tethered systems are unable to explore large craters because it would necessitate an extremely large and heavy tether. The Hedgehog system, a small robot developed by NASA, combines hopping and tumbling locomotion, and is intended for exploring asteroids. The system uses three internal flywheels to generate a reaction torque that propels that robot in any direction. This system is robust but not scalable to larger payloads due to the accompanying increase in the mass of the flywheels, which limits the efficiency of this system. Similarly, mechanical hopping systems that use springs to store energy have limited payload capacity due to the disproportionate scaling of spring mass with spring energy. Legged robotic platforms circumvent the disadvantages of wheeled rovers by being able to orient their legs and downforce independent of the terrain.

However, they are still prone to sinkage in regolith due to the higher ground pressure compared to wheeled systems and high center of mass makes them unstable. Thruster based hopping systems such as SPARROW or LEONARDO are efficient at traversing large distances. However, the exhaust from their propulsion can change the chemical composition of the ground which they land on, affecting science returns.

### BRIEF SUMMARY

According to embodiments of the present disclosure, an apparatus and system for lunar exploration robots are provided.

In some embodiments, a robot comprises a body comprising a scalable joint module having a housing including an actuator within the housing powered by a voltage regulator mounted to the housing and defining a female connector cavity of the housing; a first plurality of axial thrust roller bearings on the housing and a second plurality of axial thrust roller bearings on an opposite side of the housing, wherein each of the first and second plurality of axial thrust roller bearings are sandwiched between two washers; a male connector opposite from the female connector cavity; a head module coupled to the body, containing an onboard computing system controlling the movement of the lunar exploration robot, and an actuated latching mechanism; and a tail module coupled to the body, wherein the tail module defines a cavity configured for the actuated latching mechanism of the head module to enter, to thereby couple the head and tail modules.

In some embodiments, the body comprises a plurality of scalable joint modules linearly arranged.

In some embodiments, the actuator of each scalable joint module is daisy chained to the actuator before and the actuator behind the scalable joint module, with at least one cable tethering a daisy chained set of actuators to the onboard computing system in the head module.

In some embodiments, at least one cable transfers data from each actuator to the onboard computing system.

In some embodiments, each scalable joint module of the plurality of scalable joint modules further comprises a battery, the battery contained within a pocket defined by the housing.

In some embodiments, the body is configured to move by sidewinding and by tumbling, wherein movement is controlled by the onboard computing system. In some embodiments, a subset of the at least one scalable joint module has an axis of rotation in a vertical direction.

In some embodiments, a subset of the at least one scalable joint modules has an axis of rotation in a horizontal direction.

In some embodiments, the robot is configured to form a closed shape when the head module is latched to the tail module.

In some embodiments, the closed shape is a hexagon.

In some embodiments, the latching mechanism of the head module comprises a central driving gear and a plurality of latching fins concentric with the head module.

In some embodiments, the cavity of the tail module defines a plurality of cutouts equal to the number of latching fins on the head module, thereby preventing the head module from moving while latched into the tail module.

### BRIEF DESCRIPTION OF THE SEVERAL VIEWS OF THE DRAWINGS

FIG. 1 is a schematic diagram illustrating an exemplary operation of a COBRA robot, according to embodiments of the present disclosure.

FIG. 2 is a diagram illustrating an exemplary stowage on lunar landing and communication strategy, according to embodiments of the present disclosure.

FIG. 3 is an exemplary full body view of COBRA with 11 identical joint modules, head module, tail module, and all components, according to embodiments of the present disclosure.

FIG. 4 is an exemplary diagram of the joint module, according to embodiments of the present disclosure.

FIG. 5 is a diagram illustrating alternate cuts for an external geometry attachment, according to embodiments of the present disclosure.

FIG. 6 is a close-up of a single body module with an XC330 Actuator, actuator bracket and interchangeable arrangements, according to embodiments of the present disclosure.

FIG. 7 is an exemplary diagram of the regulator cover and cable organizer, according to embodiments of the present disclosure.

FIG. 8 is an exemplary diagram of the integrated tail module payload, according to embodiments of the present disclosure.

FIG. 9A is an exemplary diagram of the tail module payload with a cover off, according to embodiments of the present disclosure.

FIG. 9B is an exemplary diagram of the tail module payload with a cover on, according to embodiments of the present disclosure.

FIG. 10A is an exemplary head module with latching fins open, according to embodiments of the present disclosure.

FIG. 10B is an exemplary head module with latching fins closed, according to embodiments of the present disclosure.

FIG. 11 is an exploded view of a latching mechanism with head module components, according to embodiments of the present disclosure.

FIG. 12A is a diagram illustrating movement of a sheathed COBRA robot across sand, according to embodiments of the present disclosure.

FIG. 12B is a diagram of sheath fabrics, according to embodiments of the present disclosure.

FIG. 13 is an exemplary diagram of a COBRA software design, according to embodiments of the present disclosure.

FIG. 14 is an exemplary electrical architecture for COBRA, according to embodiments of the present disclosure.

FIG. 15 is an exemplary transformation of a COBRA robot, according to embodiments of the present disclosure.

FIG. 16 is a schematic diagram illustrating an exemplary payload capacity of a COBRA robot, according to embodiments of the present disclosure.

FIG. 17 is a schematic diagram illustrating an exemplary operation of a COBRA robot with inset diagrams of testing in each step, according to embodiments of the present disclosure.

FIG. 18 is an elliptical ring illustrating the COBRA tumbling configuration, according to embodiments of the present disclosure.

FIG. 19 is a schematic illustrating posture manipulation by considering two imaginary actuators, denoted as u₁ and u₂, according to embodiments of the present disclosure.

FIG. 20A is a MATLAB simulation of a reduced order model of a robot, according to embodiments of the present disclosure.

FIG. 20B illustrates a change in path of tumbling as an impulse is applied, according to embodiments of the present disclosure.

FIG. 21 is a graph showing the change in inertia along the principle axes as the lengths of axes are manipulated, according to embodiments of the present disclosure.

FIG. 22 is a series of graphs showing the impact of various impulse inputs on the velocity forward (along x) and lateral (along y) velocity of the tumbling structure, according to embodiments of the present disclosure.

FIG. 23 is a graph showing the deflection in the path of the tumbling ellipse from the no control input case upon application of various impulse inputs, according to embodiments of the present disclosure.

FIG. 24 is a graph showing the change in heading angle from the no input case upon application of an impulse input with characteristics: b′=0.4 m, t₀=2 s, γ=10, according to embodiments of the present disclosure.

FIG. 25 is an illustration of the full-dynamic model parameters in the object manipulation task, according to embodiments of the present disclosure.

FIG. 26 illustrates a series of snapshots depicting simulated forward box push utilizing various gaits executed in Matlab, according to embodiments of the present disclosure.

### DETAILED DESCRIPTION

Reference will now be made in detail to the exemplary embodiments of the present disclosure, examples of which are illustrated in the accompanying drawings. Wherever possible, the same reference numbers will be used through-out the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

Rough terrain locomotion remains a major obstacle for mobile robots, prompting exploration of various design solutions. Of these, legged robots that intermittently interact with their environment to shift the center of mass are the most promising. Unlike wheeled systems with fixed contact points, legged systems can navigate by leveraging their contact-rich locomotion capabilities. However, negotiating steep slopes with bumpy surfaces presents distinct challenges that have yet to be fully explored.

Rugged slopes are prevalent on Earth, but the most scientifically significant examples are found in outer space. The lunar surface, for instance, is riddled with craters that span tens of kilometers in diameter with surface slopes reaching tens of degrees. Their terrain, covered with porous and fluffy regolith (lunar soil), poses formidable locomotion challenges.

Lunar and space exploration, including the creation of a sustainable human basecamp on the Moon in the hope of propelling further missions to Mars and beyond. relies on In-Situ Resource Utilization (ISRU) on the Moon. One resource of significant interest is Lunar Ice/Water which can potentially supply drinking water, oxygen, and and provide raw material for rocket propellant. However, the means to access ice deposits on the Moon still require additional development.

In 2018, NASA confirmed the presence of water ice on the Moon's poles, concentrated mostly in Permanently Shadowed Regions (PSRs). The near-permanent lack of sunlight in these regions results in extremely low temperatures (as low as −238° C.) and allows for the accumulation of water ice and other volatiles. Interestingly, there are areas of near-constant illumination near some PSRs. One such PSR is the Shackleton Crater.

While the presence of “water ice” in Shackleton is evident, there are no precise measurements of its quantity or its chemical composition. In addition to more detailed observations of water content in PSRs, information on mineral concentrations and topographic maps of crater terrain are important, which requires more proximate investigations. With such acquired information, targeted mining operations can be initiated to commence ISRU. However, these regions pose environmental challenges to scientific exploration that must be addressed by an effective mobility solution.

High porosity regolith found on the South Pole and in the Shackleton Crater is a mobility challenge. Due to the regolith's high porosity, traditional wheeled rovers suffer sinkage and slipping, therefore reducing energy efficiency and increasing risk of immobilization. A second challenge is the immense slopes that must be traversed to reach areas of scientific interest inside the Shackleton Crater. The crater is a massive geographic feature, 21 kilometers in diameter. The crater slope leading to the crater floor has an average slope of 30.5 degrees and covers a horizontal distance of approximately 8 kilometers. The steep slope makes both ascending and descending difficult. On the descent there is limited traction and the regolith substrate is more prone to yielding, leading to slipping and sinkage. These factors also make it incredibly difficult to ascend the slope and state-of-the-art rovers can only climb a maximum of 30-degree inclines as they rely on sufficient friction with a surface. A third challenge is traversing uneven terrain inside the crater and surrounding area. The crater slope and floor have a root mean square (RMS) surface roughness of approximately 1 meter. As such, wheeled systems struggle to traverse the crater as the height of the obstacle they can overcome is limited by the diameter of their wheels. Additional mobility challenges include boulder fields around the crater and the unknown mechanical properties of regolith with ice.

The lack of sunlight poses two challenges: power generation and near absolute zero temperature. Traversal of the crater is limited due to the lack of solar power; therefore, large distances must be covered with minimal power consumption. Low temperatures interfere with mechanisms that rely on lubricants as well as liquid batteries. This results in less efficient power systems. The high porosity lunar dust is also abrasive and invades machinery due to its particulate nature. Overexposure to porous lunar dust without proper mitigation strategies can quickly immobilize a vehicle. Additionally, due to the lower temperatures in the PSRs, inner-crater regolith properties and their effects are not fully understood. Moreover, the lack of detailed topography of the crater floor makes navigation particularly difficult. To overcome these mobility challenges, a system must be designed with an emphasis on limiting or overcoming sinkage and slippage along with features to prevent immobilization. Most importantly, the system must traverse these environments in an energy efficient manner. It should also have both passive and active regolith mitigation strategies for longevity and performance.

One solution to traversing steep slopes is to equip wheeled systems with tethers, such as NASA Jet Propulsion Laboratory's DuAxel system. However, the size of the slope of Shackleton crater reduces the effectiveness of these solutions. To reach the center of Shackleton crater a tether many kilometers long would be required. Another solution to the traversal of steep slopes is legged systems. These systems can modify the angle of their legs externally from the orientation of their body, meaning they do not rely on friction forces for movement. However, similar to wheeled systems, the high porosity regolith causes significant sinkage of the leg assembly, leading to instability and inefficiency.

While a thruster-based hopping system might seem appropriate for covering such a large area, their exhaust may change the chemical composition of the ground that they land on, which would interfere with scientific investigation. Traditional mechanical hopping systems will have difficulty launching from the low-density regolith and are at risk of landing incorrectly and becoming damaged or stuck. One system that can take advantage of steep inclines is tumbling systems. A tumbling system utilizes gravity to travel down a slope, which requires no additional actuation, leading to extremely energy efficient travel. In many cases tumbling systems are paired with another locomotion method, such as NASA's Hedgehog robot, which combines tumbling locomotion with hopping. This system utilizes internal reaction wheels and is designed primarily for exploration of comets and asteroids. While the system is robust and efficient, the actuation method and size of Hedgehog limits the distance it can travel, payload capacity and scientific operations it can perform.

Tumbling robots such as the NASA/JPL Mars Tumbleweed Rover, offer the advantage of minimal energy consumption, making them appealing for remote exploration missions where energy efficiency is paramount. On the other hand, active rolling spherical robots like MIT's Kickbot boast a low center of gravity and omnidirectional movement capability, rendering them robust to external disturbances and adept at navigating uneven terrain. The ability of spherical robots to roll in any direction also grants them excellent maneuverability in confined spaces.

However, tumbling locomotion presents its own set of challenges. Passive rolling robots often sacrifice controllability in favor of energy efficiency, relying instead on their inherent morphology or posture for maneuvering. Additionally, rolling robots typically utilize their entire body for locomotion, posing difficulties for sensor placement such as cameras and consequently complicating localization and perception tasks.

The Crater Observing Bio-inspired Rolling Articulator (COBRA) is a robotic system that combines slithering and tumbling locomotion for the purpose of exploring PSR of craters in the lunar South Pole. In some embodiments, COBRA, is an 11 degree of freedom (DOF) robotic system that combines sidewinding and tumbling locomotion. Sidewinding locomotion refers to movement similar to that used by living snakes to move efficiently and quickly on slippery surfaces such as sand. Sidewinding involves horizontal and vertical sinusoidal waves that travel along the body of the snake, shifting sections of its body forward. Sand is often used as a terrestrial analog to lunar regolith and shares similar characteristics such as high porosity. The concept of operations begins with COBRA being delivered to the lunar surface on a Commercial Lunar Payload Services (CLPS) lander. After being deployed from the lander, COBRA can use sidewinding to move on slopes and flat ground to reach the edge of Shackleton Crater. Once it reaches the edge of the crater, COBRA can connect head to tail, forming a hexagonal loop for tumbling mode. In this loop, the center of mass can be shifted forward to initiate tumbling and control the orientation. A visualization of shifting the center of mass forward is turning a circular loop into an elliptical loop.

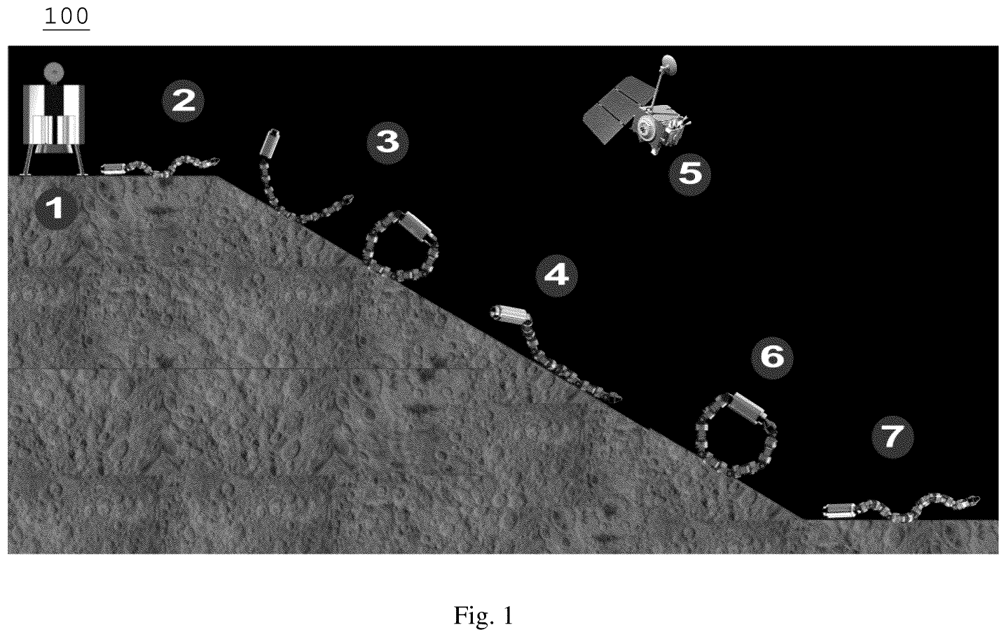

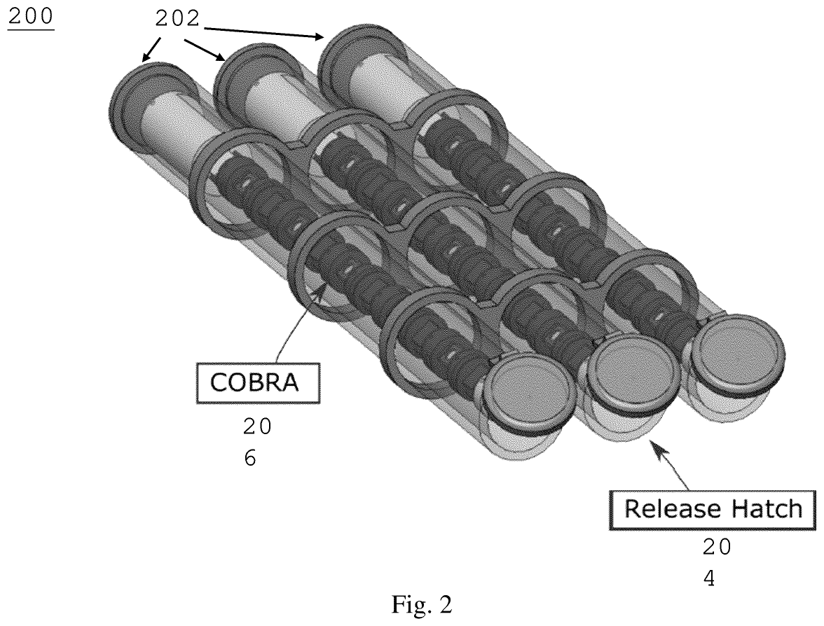

FIG. 1 is a schematic diagram 100 illustrating an exemplary operation of a COBRA robot in a lunar landing. In step 1 of the lunar landing, the mission begins with a Commercial Lunar Payload Services (CLPS) lunar lander deploying an embodiment of the COBRA near the edge of a crater, for example the Shackleton Crater. The CLPS can stow the COBRA as shown in FIG. 2.

FIG. 2 is a diagram illustrating an exemplary stowage on lunar landing and communication strategy, as can be shown in step 1 of FIG. 1. The slender frame, multiple degrees of freedom, and low mass of the COBRA system enable many options for stowage. One embodiment of the COBRA system is compatible with the Peregrine Lander from Astrobotic Technology, thanks to its small length and diameter. Another design for the COBRA stowage mechanism, one that particularly lends itself to future scalability, consists of a hollow cylinder or tube 202 where one end opens like a door (i.e., release hatch 204) to deploy the COBRA device 206. Multiple hollow tubes 202 can be connected, as shown in FIG. 2.

Once deployed, in step 2 of the operation COBRA will maneuver to the slope of the crater utilizing sidewinding. Sidewinding is a form of snake locomotion utilized to traverse loose and slippery substrates, such as sand dunes. The sidewinder snakes make use of vertical and horizontal waves that travel down the length of their body to efficiently move over sand to minimize sinkage and slippage. In sidewinding, limbless body segments (such as the modules of COBRA) are lifted and shifted forward while other body segments remain static and in contact with the ground. This method of locomotion reduces the shear forces applied at contact, which helps prevent slipping on yielding surfaces such as sand or regolith. After sidewinding to a slope, the system will take advantage of the lunar gravity by tumbling down the steep crater slope as shown in step 3. The tumbling is achieved by COBRA self-connecting the head and tail modules using a latching mechanism to transform into a near circular shape. Once connected, the system can shift its weight forward to initiate tumbling. Once in movement, COBRA joints can remain static, reducing energy consumption.

Next, COBRA will shift its mass forward to initiate tumbling down the slope of the crater. COBRA uses minimal energy to maintain the closed shape (such as a hexagon) and leverages lunar gravity to quickly travel down the crater slope, similar to a tire being pushed down a hill. Additionally, if COBRA falls over or wants to stop tumbling, it can simply disconnect its head and tail to return to sidewinding mode and reorient itself. In tumbling mode, COBRA will travel down the crater incrementally, stopping every 500 meters to disconnect its head and tail to perform in-situ measurements, as shown in step 4. COBRA's scientific payload may consist of a spectrometer, for example, located in its tail. Upon stopping, COBRA can use a mass spectrometer stored in its tail to scan for volatiles on or below the surface, namely water. The spectrometer can be positioned and aimed at specific targets utilizing the joints in the body. The system is able to create a detailed hydrogen concentration map at different depths within a crater. After performing measurements, the system sends the results to the lunar reconnaissance orbiter (LRO) utilizing a radio antenna stored in the head module of the system, as shown in step 5. In one embodiment, a communication solution is based on a tried-and-true method used by NASA's Curiosity and Perseverance rovers. A 434 MHz UHF radio transceiver and antenna capable of communicating with NASA's Lunar Reconnaissance Orbiter will be included in the COBRA system for the flight version. While the periapsis of the Mars Reconnaissance Orbiter is 255 kilometers above the south pole of Mars, the periapsis of the Lunar Reconnaissance Orbiter is only 20 km above the moon's south pole. The COBRA system has a much shorter distance to communicate over, meaning the transmission module is at a frequency equal to that used by the Orbiter with an acceptable data transmission rate at 300 kbps. The lunar orbiter can then relay the data, downlinked at 100 Mbps, through a single Ka-band ground station at White Sands, New Mexico, USA. Embodiments of the COBRA system uses a wire antenna that is ¼ the wavelength (164 mm) long which is chassis-mounted to the head module. The body of the snake can be re-oriented during data transmission to achieve optimal positioning of the antenna. This approach, opposed to relaying communications to the lander, minimizes the possibility that the signal could be subject to interference by conductive material on the lunar surface by designating the receiver as an aerial target.

By transmitting results to the lunar orbiter, COBRA does not need to expend energy climbing out of the steep crater. As shown in step 6, when the communication at the sampling location is completed, the COBRA may return to the circular formation, tumble another 500 meters, and repeat the process. In step 7, after traversing the slope of the Shackleton Crater, the system will explore the flatter center of the crater utilizing sidewinding, where it will continue to take measurements until all available power is exhausted.

Tumbling down the steep slope of Shackleton Crater harvests gravitic energy, allowing the COBRA system to travel large distances with minimal power consumption. By combining tumbling with the multiple degrees of freedom of a snake-like system, the ability to perform articulated scientific operations, with a large payload capacity, and robust maneuverability in porous and irregular terrain is obtained. The symmetric body of a snake system makes it excellent at traversing uneven and unknown terrain, by virtue of not needing to reorient itself. Additionally, the weight of the system is distributed along the entire length of its body which mitigates sinkage.

While traversing the large, steep slope of Shackleton Crater, COBRA can make intermediate stops on the crater slope to perform measurements of water ice using a neutron spectrometer in its tail. COBRA can slow down and stop tumbling by shifting its center of mass backwards. COBRA can then disconnect its head and tail entering sidewinding mode to perform measurements and manipulate the payload in its tail. After performing measurements, COBRA may send the data to a lunar orbiting satellite before returning to hexagonal tumbling mode to continue tumbling down the slope. If COBRA gets stuck or topples over, it simply returns to sidewinding mode, reorients its body down the slope and enters tumbling mode again. At the bottom of the crater, COBRA can use sidewinding to move and continue taking measurements until it runs out of power.

COBRA has multiple degrees of freedom, allowing it to maneuver scientific payloads or tools with high fidelity, unlike other mobility systems such as hoppers.

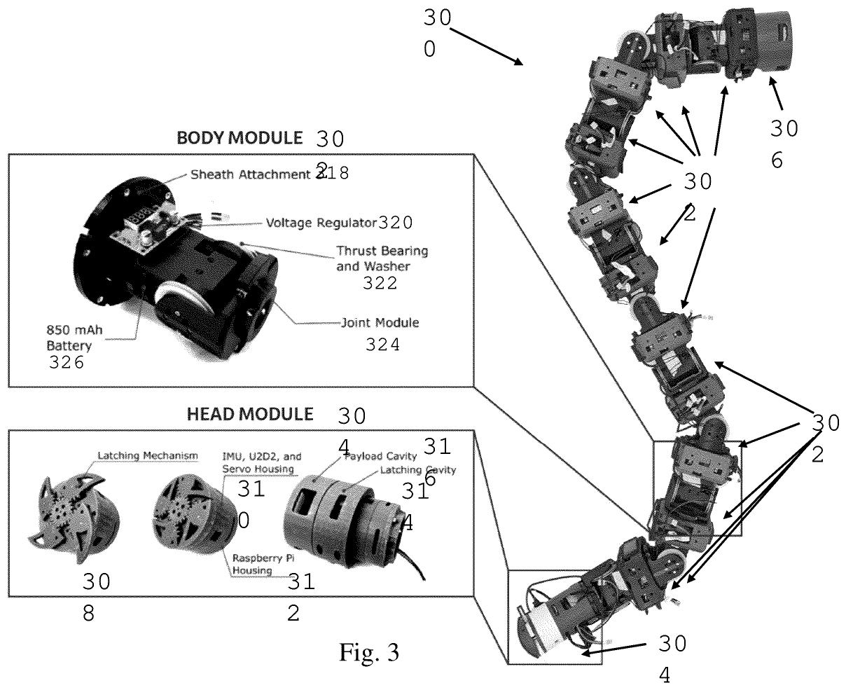

FIG. 3 is an exemplary full body view of COBRA 300 with 11 identical joint modules 302, head module 304, tail module 306, and all components of both the head and tail modules 304 and 306, shown in the inset diagrams. As shown in FIG. 3, the front of the robot consists of a head module 304 containing the onboard computing of the system, a radio antenna for communicating with a lunar orbiter, and an inertial measurement unit (IMU) for navigation. At the tail module 306, there is an interchangeable payload module. The robot has a latch mechanism in its head and tail that allows the formation of tumbling structures actively and based on commands tele-communicated to it wirelessly. Due to the large number of body joints, COBRA can actively adjust its posture to regulate its tumbling.

As shown in FIG. 3, an embodiment of the full COBRA system consists of 11 identical modules 302 each with their own joint module 324, voltage regulator 320, and battery 326, along with a head and tail module 304 and 306. The total length of the embodiment may be around 1.59 meters and 7.11 kilograms.

In addition to the 11 identical modules, some embodiments of COBRA 300 feature a distinct module at the snake's head, aptly referred to as the “head module 304,” and similarly, a “tail module 306” at the snake's tail end. The primary purpose of these unique modules is to connect together to form a loop prior to the onset of tumbling mode. The head module, as shown in FIG. 3, acts as the male connector and utilizes a latching mechanism 308 to sit concentrically inside the female tail module. COBRA's head module also houses a Raspberry Pi Zero W (along with a LiPo battery for power and its accompanying voltage regulator) in Raspberry Pi housing 312, an inertial measurement unit (IMU) and the Dynamixel U2D2 motor controller, both housed in the IMU, U2D2 and Servo Housing 310.

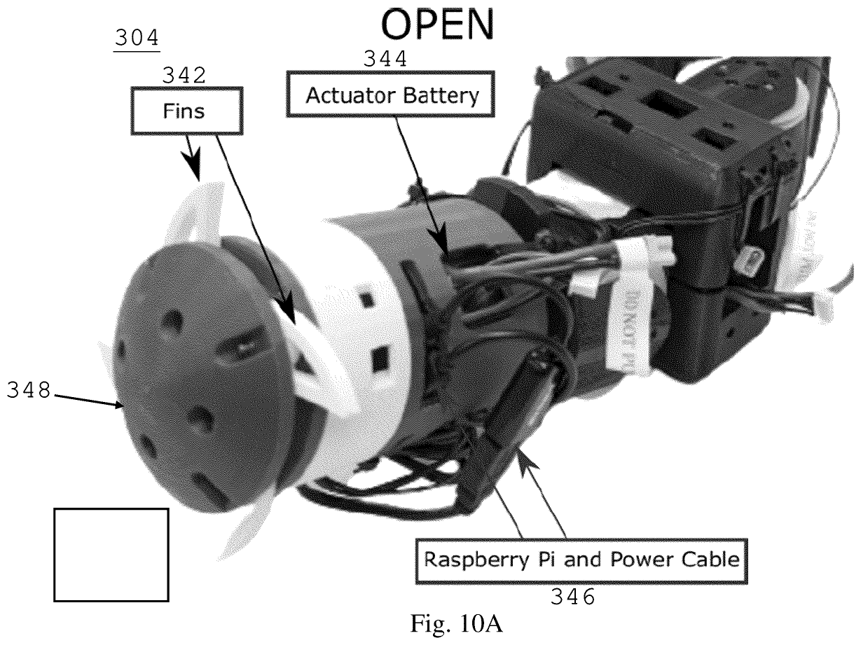

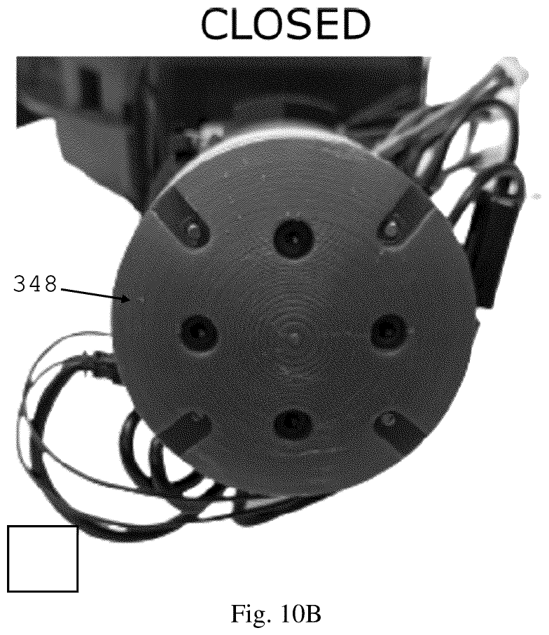

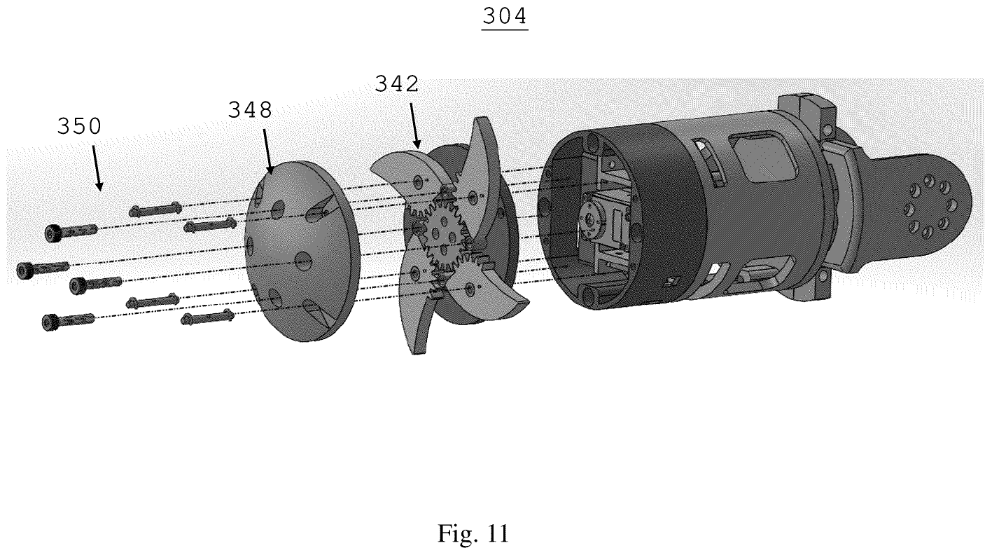

The latching mechanism 308, shown exploded in FIG. 11 and in additional detail in FIGS. 10A-B, consists of a Dynamixel XC330 actuator, manufactured by Robotis, Inc. of Lake Forest, California, which sits within the head module and drives a central gear. This gear interfaces with the partially geared sections of four fin-shaped latching “fins.” The head module 304 also includes a payload cavity 316. COBRA's tail module features a female cavity for the fins. When transitioning to tumbling mode, the head module is positioned concentrically inside the tail module using the joint's actuators, and the fins unfold into the cavity to lock the head module in place. For the head and tail modules to unlatch, the central gear rotates in the opposite direction, and the fins retract, allowing the system to return to sidewinding mode.

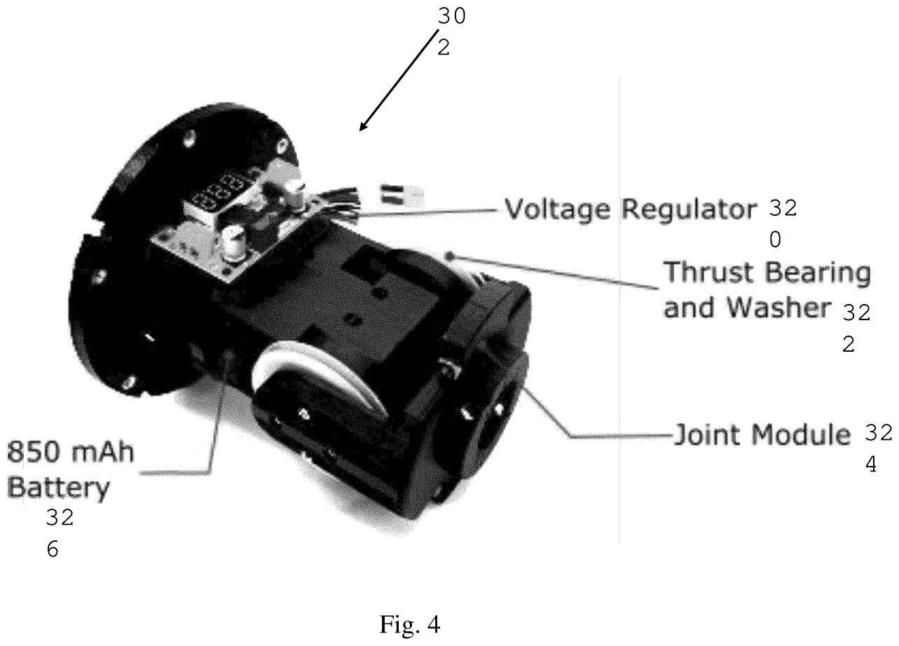

FIG. 4 is a larger view of the joint module 302. For the full-scale COBRA system, Dynamixel XH540-W270 actuators may be used based on their high torque-to-weight ratio. These motors provide a maximum torque of 9.9 newton-meters at the recommended 12 volts. This provides a safety factor of approximately 2 for a maximum expected torque during the transformation from slithering to tumbling mode. Markforged 3D printers may be used to fabricate the modules with Onyx, a material that combines carbon fiber with nylon leading to extremely strong and lightweight structures. A single module can be split in half for printing and assembly and can be connected using 3 bolts. The module also features two needle-roller thrust bearings and washers 322 to handle axial loads, while the radial bearings in the actuators are already sufficient. The thrust bearings are held between two washers with grease to reduce friction between the bearings and the 3D printed parts. Each module also includes a battery 326 and voltage regulator 320 for powering the actuator. Next, cables run between each module to daisy chain the actuators to the head module which contains the motor controller. An external sheath attachment 318 protects the voltage regulator and battery connector as well as directing cables between modules neatly. The external sheath attachment 318 feature a symmetrical 4 bolt pattern that joins the male joint section with the female housing section of the next module. In some embodiments, a total of 11 modules 302 are connected in alternating vertical and horizontal direction to assemble the whole COBRA system. A single assembled joint module may weigh 592 grams and can move a full 180 degrees.

The system is also easily scalable thanks to its modular design; increasing the number of modules and actuators would allow it to carry larger payloads. By virtue of the symmetrical cylindrical body and locomotion method, there is no “upright” orientation for COBRA, meaning it does not have the risk of falling over or becoming immobilized in a certain configuration. COBRA can also maneuver around large obstacles, crawl out of holes and loose regolith thanks to its multi-DOF body. In summary, COBRA enables efficient and robust mobility in extreme terrain that existing rovers cannot traverse by combining sidewinding and tumbling locomotion into one robotic platform. The sub-assemblies, such as structural housing, actuators, and batteries can be easily scaled. The overall design does not need to be changed; only scaling the modules is required.

In various embodiments, the full terrestrial COBRA prototype is 1.59 meters long, 0.12 meters maximum diameter and weighs 7.11 kg. IN some of these embodiments, the system comprises 11 identical joint modules and a unique head and tail module. Each joint module has an actuator (Dynamixel XH540-W270, manufactured by Robotis, Inc. of Lake Forest, California,), a battery (14.8V, 850 mAh LiPo) and a voltage regulator. The voltage regulator steps the voltage down from a voltage level supplied by the battery (e.g., 14.8 V) to a voltage level required to power the actuators (e.g., 12 V). In various embodiments, the structure of the joint module may be formed from 3D printed nylon and carbon fiber. In various embodiments, the joint module may be printed by the Markforged ‘Onyx’, manufactured by Markforged, of Waltham, Massachusetts. This housing is split in half for printing and then may be fixed together using three bolts and heat-set inserts. The actuator may be fixed with 8 bolts inside the housing. The battery sits in a pocket in the housing. The voltage regulator is mounted on the top of housing. Axial thrust roller bearings are included on either side of the joint to increase the axial load capacity. These bearings are sandwiched between two lubricated fiberglass washers to minimize friction. The output portion of the joint module is also split into two halves for printing and fixed together using two bolts. Each half is fixed to the output shaft of the actuator with 4 bolts. The output portion of the joint module features a male connector with 4 heat-set inserts arranged in a circular pattern. The portion of the joint module containing the actuator and battery features a female connector cavity that the male connector fits into. Four bolts are tightened through the female and male portions to rigidly connect them. It is through this symmetrical connector that allows the joint modules to be connected to one another in alternating directions.

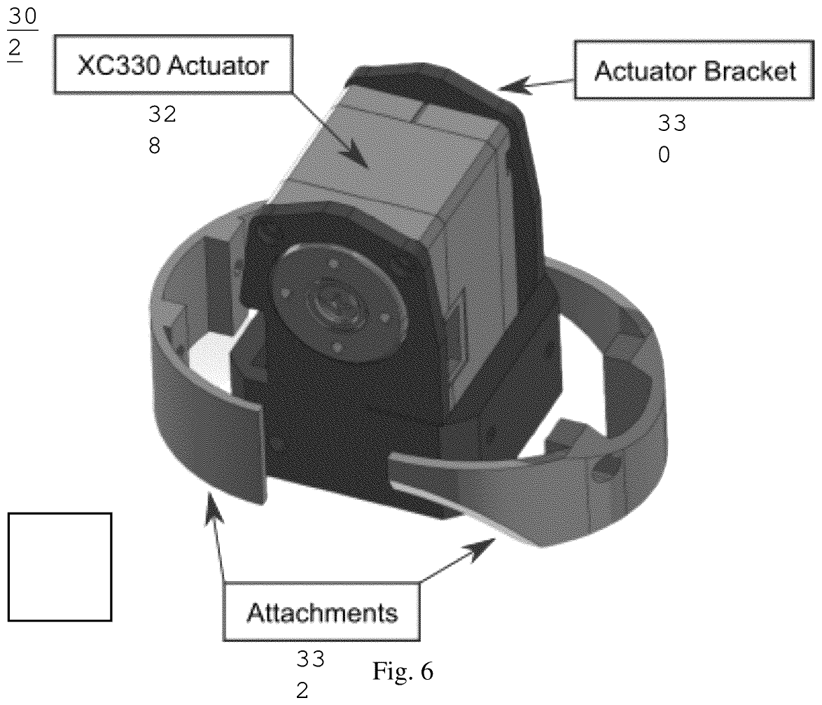

FIG. 6 is a close-up view of a single body module 302 with an XC330 Actuator 328, Actuator Bracket 330, and interchangeable Attachments 332. The attachments may be used to rapidly experiment with different exteriors to determine ideal shapes for sidewinding and tumbling. As seen in FIG. 4, actuator brackets 330 were designed to allow for interchangeable external geometry attachments on the system. Differently shaped attachments 332 were used to target our individual mobility solutions. Circular, elliptical, and square attachments were tested to determine the shape to optimize sidewinding and tumbling configurations.

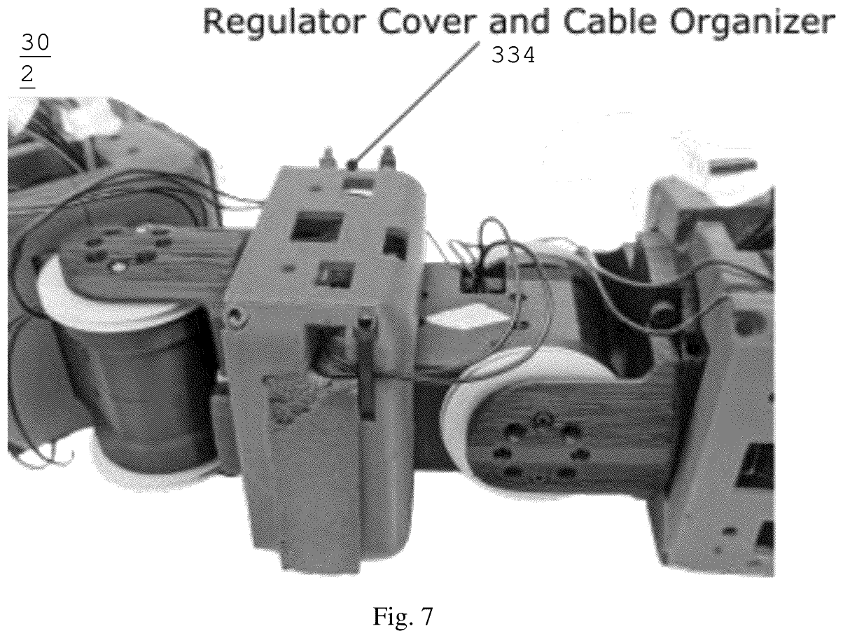

FIG. 7 is an exemplary diagram of the regulator cover and cable organizer 334 over a body module 302. The regulator cover and cable organizer 334 functions to keep all debris out of the COBRA body and cabling system, while promoting efficient movement of the COBRA.

The power delivery system for some embodiments of the COBRA is simple, as the power demand for these smaller motors is within a range where a central power supply can be used to power the chain of 11 motors. The stall current draw for each of the XC330-M181 motors is listed at 1.80 A and the mass of each motor (which dictates the load displaced by the motors) is only 23 g. After having done tests to determine the current draw under the expected load, it was determined the entire chain of motors could be powered with two 5V, 3 A outputs of a power supply connected in parallel. Exemplary parameters and values are provided in Table 1, below.

TABLE 1
Joint Module Parameters

| Parameters | Values | |
|---|---|---|
| Torque | 9.9 | Nm |
| Voltage | 12 | V |
| Range | +/−180° | |
| Mass | 0.59 | kg |
| Power | 850 | mAh |

The actuators are daisy chained together, with cables running between each module to transfer data to the on-board computer stored in the head module. An additional 3D printed square bracket made of polylactic acid (PLA) is fixed on each module to protect the voltage regulators and cables and to increase the width of the system for increased stability when tumbling.

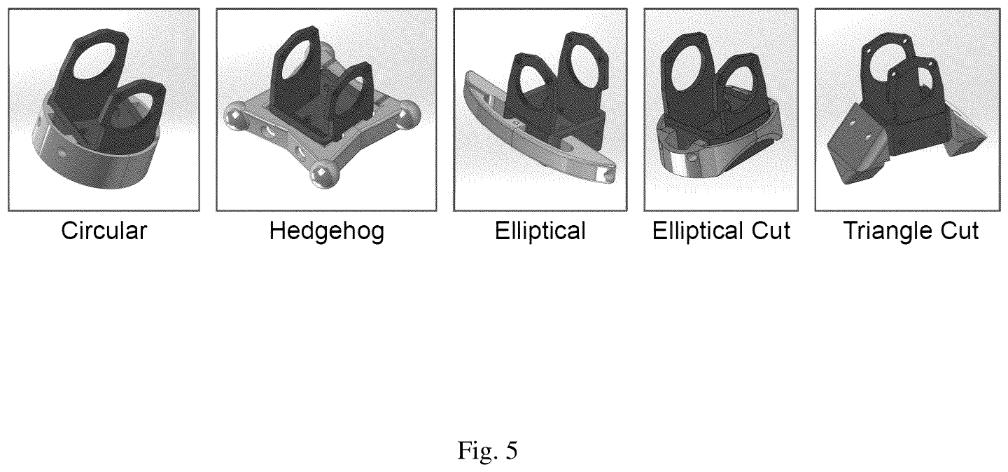

FIG. 5 illustrates possible external attachment geometries for embodiments of the COBRA device. Each of the illustrated geometries was tested during movement of embodiments of the COBRA device, with a square attachment providing the most stability while the COBRA tumbles.

There are 5 joint modules with the axis of rotation in the vertical direction and 6 joint modules in the horizontal direction. There are 6 in the horizontal direction to enable transformation into a hexagon for tumbling. There are only 5 in the vertical direction to make space for the head and tail module whose length make up the length of two joint modules. This is done so that when connected in hexagon mode, all sides of the hexagon are the same length.

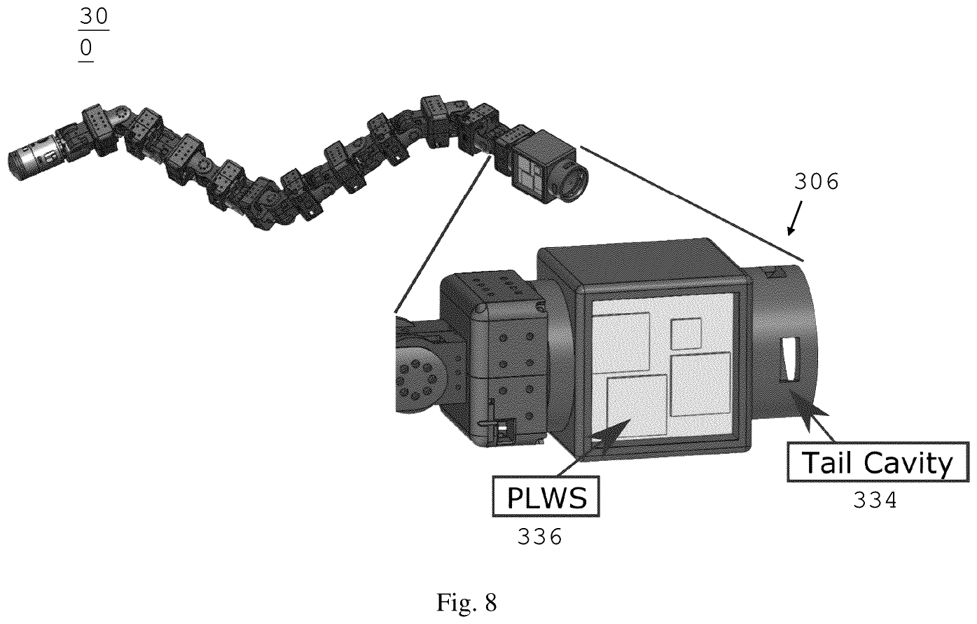

FIG. 8 is an exemplary diagram of the integrated tail module 306 payload, according to embodiments of the present disclosure. The tail module 306 defines a tail cavity 334, wherein the latching mechanism 308 of the head module 304 latches into when the COBRA is in a tumbling mode. The tail module 306 also features an exemplary Puli Lunar Water Snooper (PLWS) 336 mounted on the housing of the module 306

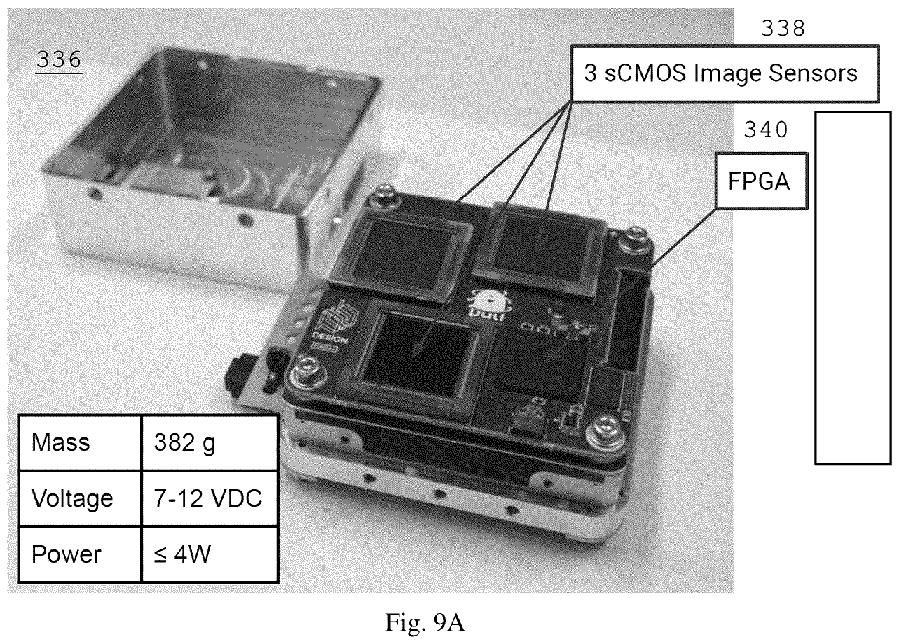

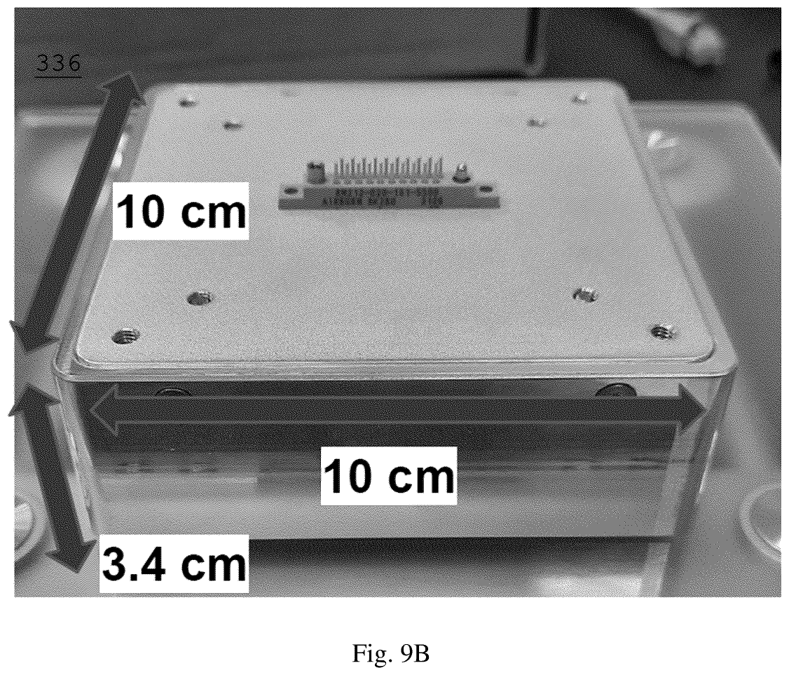

FIG. 9A is an exemplary diagram of the tail module 306 payload with a cover off, with the exposed circuity of an exemplary PLWS 336. The PLWS circuity includes 3 sCMOS Image Sensors 338 and an FPGA 340. As indicated by the inset table, the mass of the PLWS 336 is 382 g, with 7-12 VDC voltage and power of less than or equal to 4 W.

FIG. 9B is an exemplary diagram of the tail module 306 payload with a cover on, with inset exemplary dimensions of the PLWS 336.

The tail module 306 is the intended location to house the payload. The PLWS 336 uses 3 MOTS sCMOS image sensors 338 (thermal neutrons, epithermal neutrons, and a reference sensor) as detectors, as shown in FIG. 9A. The PLWS is a low-cost, COTS-based system with an FPGA. It has an envelope of 10 cm×10 cm×3.4 cm and a mass of 382 g as shown in FIG. 9B, making it a small lightweight scientific payload that can fit within the tail module of COBRA. The PLWS can allow for significant scientific readings throughout COBRA's mission scenario.

The head module contains the onboard computing for the system and an actuated latching mechanism. The following components are inside the head module, a Raspberry Pi Zero (sold by Raspberry Pi, Ltd. of Cambridge, Cambridgeshire, United Kingdom), U2D2 Dynamixel Motor Controller (manufactured by Robotis, Inc. of Lake Forest, California), Dynamixel XC330-M288 Actuator (manufactured by Robotis, Inc. of Lake Forest, California) for driving the latching mechanism, 14.8 V LiPo battery, and 5V voltage regulator. The 5V voltage regulator steps the 14.8V down to 5V to power the Raspberry Pi and XC330 actuator in parallel. The latching mechanism consists of a central driving gear and four latching fins concentric with the head module. When in stowed configuration the fins fit within the maximum diameter of the head module. When deployed they flare out, exceeding the maximum diameter on the head module. On the tail module are four complementary cutouts for the fins to expand into. Starting with the fins stowed, transformation into tumbling mode begins with the head module being positioned inside the tail module cavity at a specific depth to align the fins with the cutouts. Once at the correct depth, the central driving gear is turned, unfolding the latching fins into the cutouts. The fins are now inside the cutouts which prevents the head from moving forward or backward in the tail module, rigidly coupling the two parts. The tail module contains a cavity for the head module to enter and four through-hole cutouts arranged in a circular pattern for the latching fins. In various embodiments, this is where a neutron spectrometer can be stored to perform water ice measurements. An exemplary spectrometer system that could be included as a payload is the Puli Lunar Water Snooper from Puli Space Technologies of Budapest, Hungary.

FIG. 10A is an exemplary head module 304 with latching fins 342 open, according to embodiments of the present disclosure. FIG. 10B is a complementary illustration of head module 304 with latching fins 342 closed. The curved outer face of each latching fin 342 has an arc length equal to ¼ of the circumference of the head module 304's circular cross section. When the mechanism is retracted, these four fins 342 form a thin cylinder that coincides with a cylindrical face of the head module 304, and when the mechanism is extended, the fins extend through a latching cavity 314. A dome-shaped cap 348 lies on the end of the head module so that the fins 342 sit between it and the main body of the head module. Clevis pins are used to position the fins in this configuration. The head module 304 further comprises an actuator battery 344 as well as a Raspberry Pi and associated power cable 346, which control the movement of the COBRA body.

FIG. 11 is an exploded view of a latching mechanism with head module 304 components. The choice for an active latching mechanism design stemmed from the design requirements and restrictions. Magnets were initially discussed as a passive latching option, however they are not effective in conjunction with the ferromagnetic regolith. Further, due to the need to stay in a latched configuration even when a large amount of force is applied to the system during tumbling, a passive system was not ideal, for there would be the risk of unlatching during tumbling. The chosen design connects the head and tail modules fairly rigidly and minimizes the possibility of latching failure during tumbling. Shear load on the latching fins 342 was considered through rough analysis of the maximum shear stress of different configurations of carbon fiber reinforcement layers within the 3D-printed parts. Ultimately, these fins 342 are designed to be sufficiently thick-6 mm-and include three, equally spaced layers of carbon fiber reinforcement, each a few layers thick. This latching mechanism design was also chosen for its ability to be dust proofed through close clearancing (running fits) between the fins 342 and the dome 348 and latching plate, so when the fins are closed, there is little to no gap to enable dust infiltration. Screws and bolts 350 ensure the closure of the latching system.

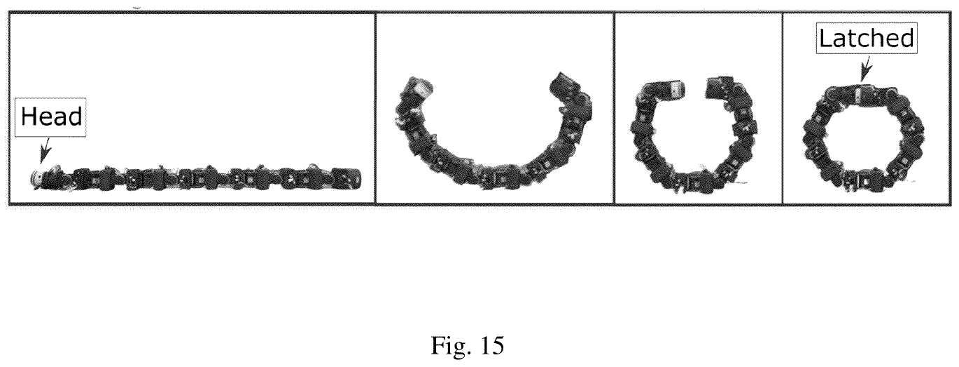

FIG. 15 is an exemplary transformation of a COBRA robot, according to embodiments of the present disclosure. The illustrated transformation includes the head and tail modules latching to form a closed shape. The tumbling movement performed by the COBRA involves two stages: (1) changing to the closed form configuration; and (2) initiating tumbling down a sloped surface.

Before the first stage was tested, a torque test was performed using half of the system. Module 0 was clamped to the table and the torque was measured as it lifted Modules 1-6. This test was done to ensure the actuators were able to lift the system without overloading. Based on the maximum torque of the actuators, the system can increase 1.5 times in mass before an overload occurs.

The first stage was then tested on a flat floor. The system was able to properly transition into the hexagon (closed shape) formation; however, in the first iteration the head and tail modules hit into each other with a significant amount of force. To mitigate this force, the transformation was split into two separate sections. The first brings the modules halfway into the configuration and then pauses for three seconds to allow for the system to settle. The head and tail are then moved together at a slower acceleration until the hexagon formation is reached. After this stage, the latching mechanism can initiate, extending the legs outwards until they hit the cavity on the tail module.

Tumbling for Stage 2 was tested outdoors on ramps with inclines of 4 and 8 degrees. To test tumbling, COBRA was placed parallel to the slope such that Module 6 was on the beginning of the sloped section. The transformation to hexagon was initiated and then COBRA was tilted forward to create enough force to continue tumbling down the slope. COBRA had some trouble maintaining continuous motion on the 4 degree incline, stopping every 3-4 m, however performed much better on the 8 degree incline going the full 20 m length of the slope. COBRA was then tested in its full mission scenario, sidewinding to the edge of the slope, transforming into the hexagon configuration and then tumbling down the slope.

Covering the entirety of COBRA is a flexible sheath that protects the joints and electronics from dust infiltration. For the terrestrial prototype, this sheath is constructed from a 3 mm thick neoprene. The sheath is a long tube of the neoprene material that slips over the entire body of COBRA. The sheath is longer than COBRA to provide sufficient flexibility and slack for when COBRA is rotating its joints during sidewinding and transforming into tumbling mode. In various embodiments, the ends of the sheath are sealed using zip ties. In various embodiments, various bolted clamping fixtures to close the sheath off at either end may be utilized.

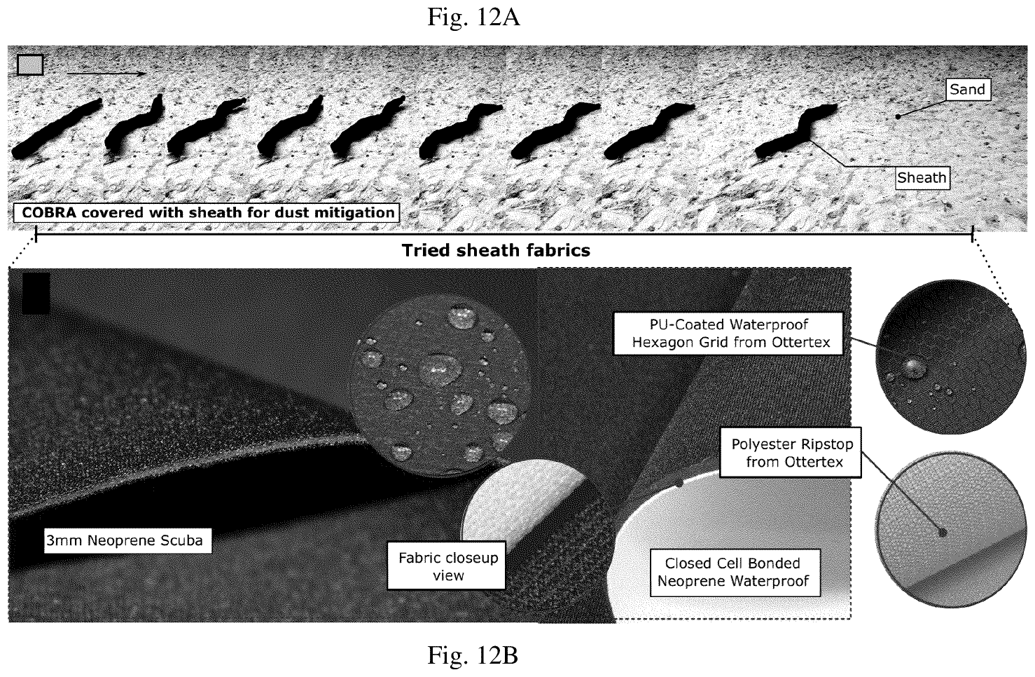

FIG. 12A is a diagram illustrating movement of a sheathed COBRA robot across sand. The inclusion of a sheath was considered as the sheath prevents debris from entering the COBRA during movement and is described below. FIG. 12B is a diagram of exemplary sheath fabrics, according to embodiments of the present disclosure.

As COBRA is meant to work in highly porous and abrasive lunar regolith it is essential that these fine particles do not infiltrate the system and impair joint movement. To protect against this, a tubular sheath was implemented to cover the system's main body from head to tail. The idea of having individual sheaths for each module was explored, however, due to increased complexity and chances of failure, a longer, single sheath was used. In some embodiments, the sheath is a 1.62 meters long fabric that has one seam to make it a 390 mm diameter tube that tightly fits over the system, while not interfering with joint movement. Understanding the abrasiveness of regolith and the risk of having holes in the sheath, the fabric must have high abrasion resistance and durability. In some embodiments, fabrics include 2 mm neoprene, 3 mm neoprene, closed cell bonded neoprene, and urethane coated polyester. Neoprene has high tear and abrasion resistance while having flexibility that allows for free joint movement. Urethane coated polyester fabric likewise has high tear and abrasion resistance, however, has very minimal flexibility. This fabric has similar mechanical properties to Kevlar and Vectran which may be considered as sheath materials, depending on how polyester performs compared to the neoprene fabric.

Based on initial sheath tests, the idea of using a tube shape made of neoprene does not hinder any of COBRA's movements. While running the sidewinding program, there is virtually no difference between COBRA's movements with or without the 3 mm neoprene sheath and the same when transformed into tumbling mode. Further, a relative current sensing test of a Dynamixel motor in a single module was used to measure whether the sheath added resistance to the motor articulation. For angles less than 80° the current sensing values were practically the same as the module with no sheath. At angles higher than 80°, the current sensing values rose exponentially, however, this is not a concern since COBRA's modules are not meant to articulate more than +70°.

The seam for each neoprene fabric was tested for how well it could keep out fine particles by stretching the seam over a container and pouring fine gravel on top. This was then shaken for a minute and the weight of the container was weighed and compared to the weight prior to pouring the gravel on top. For each of the neoprene fabrics, there was no change in weight before and after the test, meaning the seam does not allow for any particles to pass through.

To prevent any regolith from interfering with the head and tail modules, two embodiments of protection are possible for either end. For the head, a skin concept with material that is more flexible than the body's sheath is being pursued that both protects the latching mechanism while allowing the blades to fan out fully. As for the tail and its female cavity, an iris diaphragm concept has been ideated to act as a door. For this mechanism, a co-centered outer ring is turned by a servo with respect to an inner ring, which turns the iris blades between them. One end of each iris blade is attached to the outer ring by a pivot assembly and the other to the inner ring by a slider assembly. Thus, as the outer ring turns, the blades will both slide and turn to either open up or close off the cavity to allow the head to enter and exit with minimal regolith interference.

The COBRA software is a collection of classes, functions, and scripts meant to perform the necessary computation to achieve the robot's unique combination of mobility techniques. A set of controller classes handle the calculation for the different types of movements, such as sidewinding, hexagonal and spiral transformations. These classes handle the calculation of the specific angles to turn each actuator for each specific movement. Sidewinding class converts horizontal and vertical sinusoidal waves into specific joint angles. The hexagonal transformation class handles transformation into a hexagon, actuation of the latching mechanism and using the joints to shift the center of mass forward to initiate tumbling. Spiral tumbling class is an alternative tumbling method in which COBRA becomes coiled like a spring, increasing its width for tumbling. These controller classes interact with a driver class written to handle communication with the motors. Functions enabling movements are able to be called by other applications, such as a script that takes in keyboard presses/strokes from an external laptop to control the robot remotely. In various embodiments, COBRA is controlled by using a laptop connected to the onboard Raspberry Pi via SSH and running this driver class script to activate different movements using keyboard presses/strokes. The software performs sidewinding by actuating the motors in a cyclical manner, the exact patterns of these movements might vary. In various embodiments, integrated inertial and terrain sensing may be included in the system. In various embodiments, path-planning and autonomy systems/software may be included in the system. In various embodiments, the software tech stack may be made of open-source tools such as Dynamixel SDK and Python.

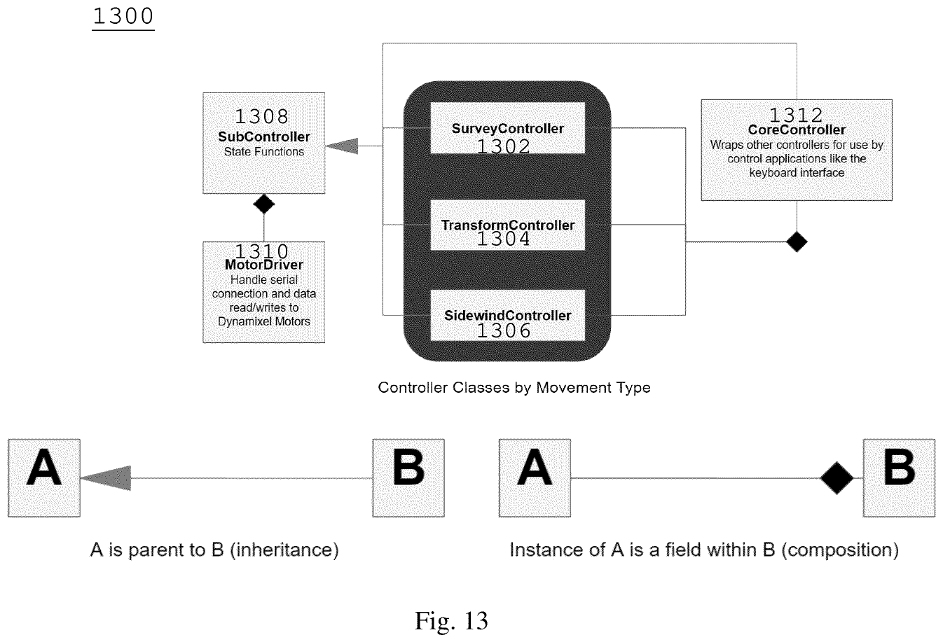

FIG. 13 is an exemplary diagram of a COBRA software design. An onboard computing system 1300 comprises a series of controllers dependent on movement type, including a survey controller 1302, a transform controller 1304, and a sidewind controller 1306. Each controller, when active, sends a signal to subcontroller 1308 in communication with motor driver 1310. Core controller 1312 also provides input to system movement.

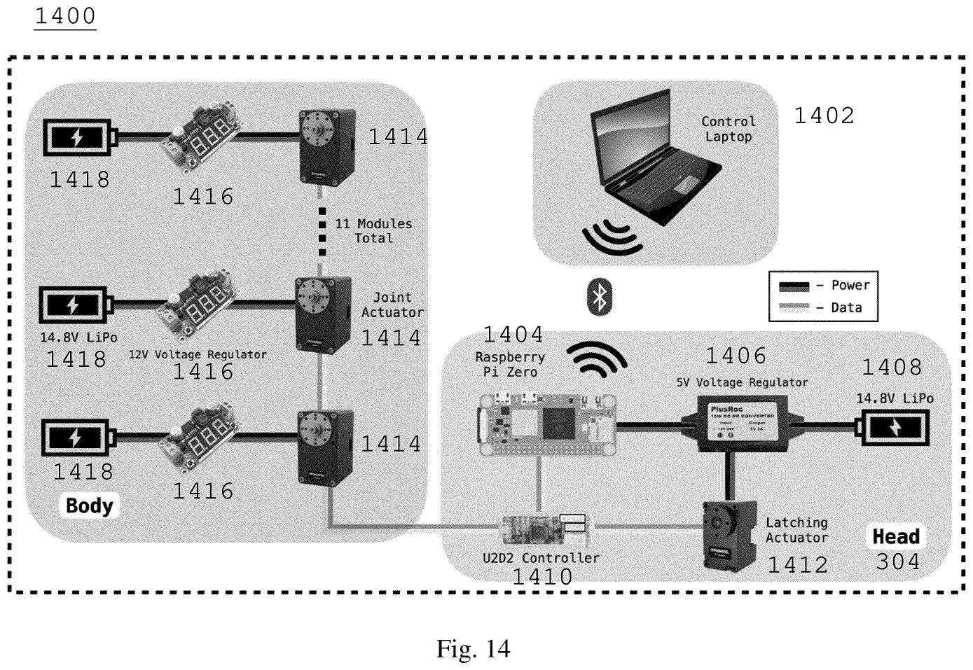

FIG. 14 is an exemplary electrical architecture 1400 for COBRA. With this power distribution topology, the weight of the supplied power is distributed evenly. Inside each module, individual batteries 1418 are connected through a voltage regulator 14116 to each actuator 1414. This design simplifies power draw calculations and contributes to the modularity of the system. Any number of modules can be added or removed without affecting the overall functionality. This power distribution topology is also resilient to the failure of one or more of its individual modules, providing an extra layer of fault tolerance. To power the actuators 1414, GensTattu 850 mAh 14.8V LiPo batteries were chosen as they are fairly light (107 g) and easily fit inside the module (60 mm×30 mm×30 mm), while also providing a run time of 17 minutes at an average current of 3 A.

Within the electrical architecture of COBRA there is room for the implementation of radar sensors and an IMU. To integrate an IMU, a microcontroller 1410 is connected to the Raspberry Pi 1404 via micro USB. With the IMU attached to the microcontroller 1410, the acceleration, angular velocity, and orientation of COBRA can be recorded by the Pi 1404. This data will be especially useful in tumbling mode, as COBRA will be able to autonomously detect when it has fallen over. When this is detected, COBRA will be able to unlatch and reconfigure itself into hex mode to continue the tumbling motion. As COBRA is unlatched, the radar sensors can be utilized to map the surrounding area. These will be wired to a connector board that is compatible with the GPIO pins on the Pi 1404. The onboard computing system in the head module 304 is powered by battery 1408. In turn, battery 1408 powers latching actuator 1412, and is run through voltage regulator 1406. Raspberry Pi 1404 communicates with control laptop 1402 via Bluetooth.

COBRA source code may be Python run through an interpreter, controlled via a remote terminal (such as laptop 1402) connected to the onboard Raspberry Pi 1404. The system can be controlled through a text-based program. This application can command the system to sidewind and transform into different shapes such as a spiral or hexagon for tumbling.

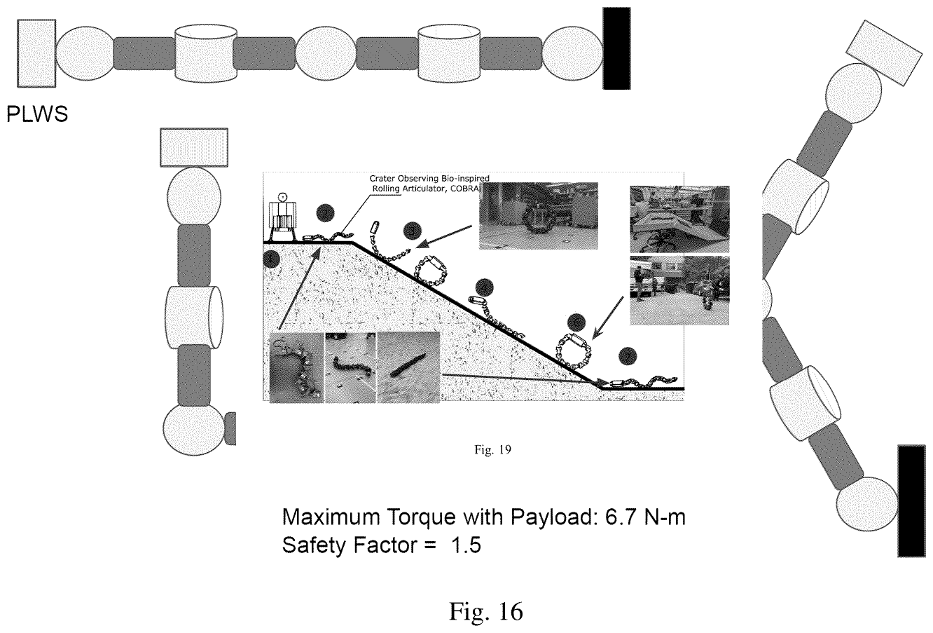

FIG. 16 is a schematic diagram illustrating an exemplary payload capacity of a COBRA robot, according to embodiments of the present disclosure.

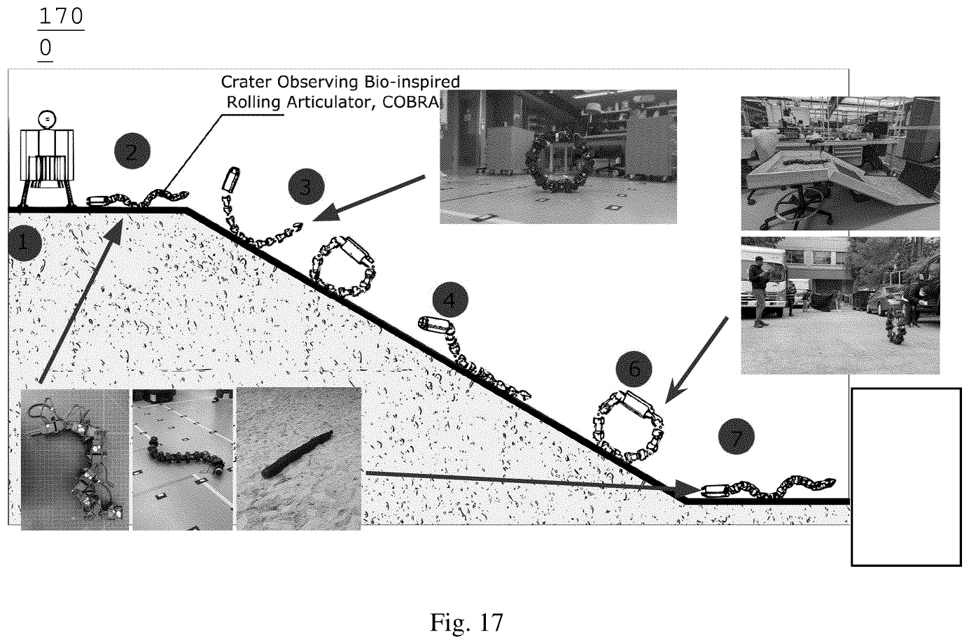

FIG. 17 is a schematic diagram illustrating an exemplary operation of a COBRA robot with inset diagrams of testing in each step, similar to FIG. 1. Here, a schematic diagram 1700 illustrates an exemplary operation of a COBRA robot in a lunar landing. In step 1 of the lunar landing, the mission begins with a Commercial Lunar Payload Services (CLPS) lunar lander deploying an embodiment of the COBRA near the edge of a crater, for example the Shackleton Crater. Once deployed, in step 2 of the operation COBRA will maneuver to the slope of the crater utilizing sidewinding. After sidewinding to a slope, the system will take advantage of the lunar gravity by tumbling down the steep crater slope as shown in step 3. The tumbling is achieved by COBRA self-connecting the head and tail modules using a latching mechanism to transform into a near circular shape. Once connected, the system can shift its weight forward to initiate tumbling.

Next, COBRA shifts its mass forward to initiate tumbling down the slope of the crater. COBRA uses minimal energy to maintain the closed shape (such as a hexagon) and leverages lunar gravity to quickly travel down the crater slope, similar to a tire being pushed down a hill. In tumbling mode, COBRA will travel down the crater incrementally, stopping every 500 meters to disconnect its head and tail to perform in-situ measurements, as shown in step 4. Upon stopping, COBRA can use a mass spectrometer stored in its tail to scan for volatiles on or below the surface, namely water. After performing measurements, the system sends the results to the lunar reconnaissance orbiter (LRO) utilizing a radio antenna stored in the head module of the system, as shown in step 5.

By transmitting results to the lunar orbiter, COBRA does not need to expend energy climbing out of the steep crater. As shown in step 6, when the communication at the sampling location is completed, the COBRA may return to the circular formation, tumble another 500 meters, and repeat the process. In step 7, after traversing the slope of the Shackleton Crater, the system will explore the flatter center of the crater utilizing sidewinding, where it will continue to take measurements until all available power is exhausted.

A financial advantage is derived from COBRA's efficient mobility capabilities in permanently shadowed craters. By leveraging tumbling locomotion, the distance that COBRA can traverse and the science it can perform compared to its energy requirements and size greatly outweighs existing systems. Due to the high cost of sending payloads to space, often quoted in terms of dollars per kilogram, the small mass and volume of the COBRA system provides extreme financial advantage by sending COBRA as a robotic precursor to look for water ice. For example, the dry mass of NASA's VIPER rover is 483 kg. The COBRA terrestrial prototype only weighs 7.11 kilograms, meaning many COBRA systems could be sent to explore for the cost of a single wheeled rover.

There are also many costs-savings from a manufacturability and scalability viewpoint due to the modularity of COBRA. First, once a module is designed, built, and verified, it is simple to repeat the process for 10 more modules, connecting them together. This is different from other more complex robotic systems made up of hundreds of unique parts and subassemblies which each have to be verified on their own. Additionally, the payload module is located on the end of the COBRA system, you only need to modify a single subassembly to accommodate any payload, without having to modify the entire robot.

Secondly, for scalability it is simple to add on additional modules to increase the length of the system for improved obstacle clearance as the modules are identical. For scaling the modules up in size to accommodate larger payloads, the sub-assemblies can be easily scaled, such as structural housing, actuators, and batteries. The overall design does not need to be changed; the modules only need to be scaled.

These factors drive costs down for the system greatly compared to complex wheeled rovers and other complex robotic systems.

### EXAMPLES

### Reduced-Order Model (ROM) Derivations

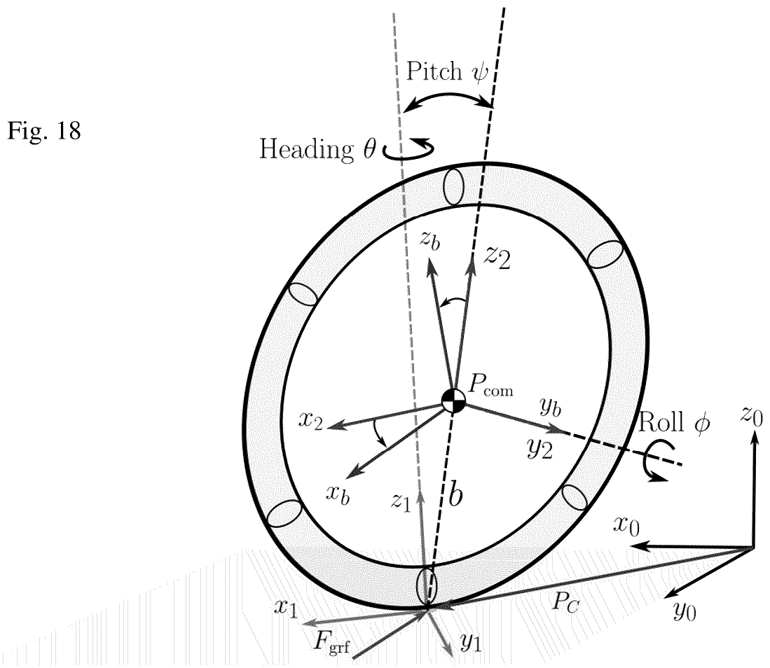

In the tumbling configuration, COBRA is reduced to an elliptical ring, as depicted in FIG. 18. Throughout these derivations, the following assumptions are made:
The ring has a negligible cross-section area;
Mass distribution is uniform;
The shape of the ring is parameterized by the lengths of its principal axes, u₁ and u₂, controlled by the actuation of joints in the robot; and
All achieved postures are symmetric, ensuring that the center of the ellipse aligns with the center of mass (CoM).

With these assumptions in place, the inertia tensor of the ring [symbol] (uᵢ), manipulated by uᵢ. Subsequently, the inertia tensor is utilized to derive the nonholomic equations of motion of the rolling ring, as the control actions manipulate the ring's posture.

### A. Cascade Model

In one approach to mathematically formulating tumbling servoing using shape manipulations in the ring, a cascade nonlinear model of the following form is presented:

$${\sum }_{tbl} : \dot{x} = f ( x , y ) \\ {\sum }_{pos} : \{ \begin{matrix}\dot{ξ} = {f}_{ξ} ( ξ , u ) \\ y = {h}_{ξ} ( ξ )\end{matrix} \qquad ( 1 )$$

Here, x and y represent the state vector and output function, encapsulating the ring's orientation (Euler angles, CoM position) and mass moment of inertia about its body coordinate axes (x-y-z). The function f(·) governs the dynamics for the states x.

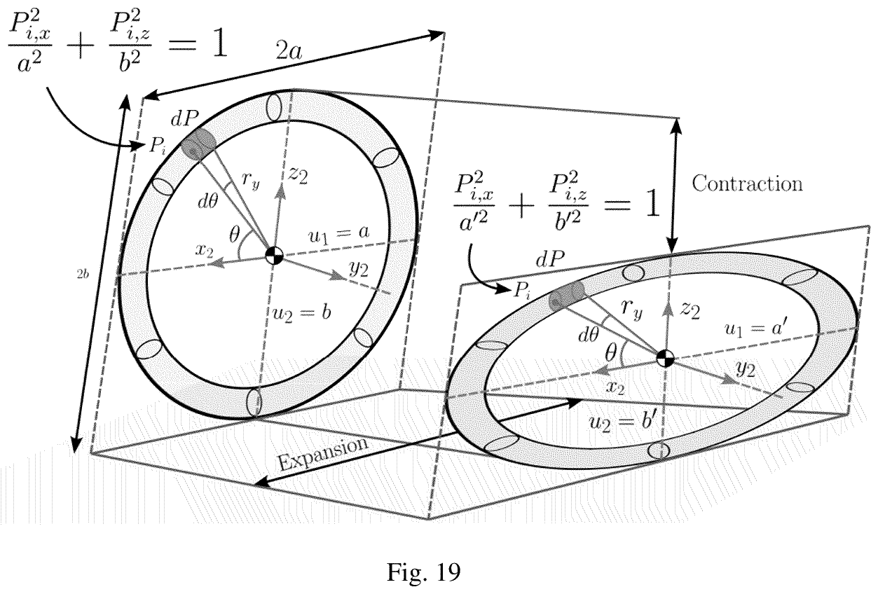

Additionally, f₈₆ , and h_{ξ} represent the dynamics governing the internal states ξ. u denotes the actuation effort along the principal axes of the ring as shown in FIGS. 18 and 19. The cascade model assumes separate governing dynamics for tumbling Σ_{tbl} and posture manipulation Σₚₒₛ, considering a specialized case of tumbling that uses internal posture manipulation to maintain the shape of the robot with respect to the inertial frame. Below, the equations for each model are derived.

FIG. 19 illustrates posture manipulation by considering two imaginary actuators, denoted as u₁ and u₂, which act along the principal axes of the ring to induce planar deformations.

### B. Governing Dynamics for Posture Manipulation Σₚₒₛ

As illustrated in FIG. 18, the control actions u=[u₁, u₂]^{T} are considered to adjust the length of the principal axes for the ring. Therefore, the objective is to derive the governing equations for posture dynamics.

While there is no closed-form equation for the perimeter of an ellipse, several approximations exist that are sufficiently accurate. One such approximation is employed to maintain the perimeter at a fixed value as the length of the axes changes. However, for calculating the inertia tensor for this line mass, the following approach utilizing integrals provides a mathematically simpler method that can subsequently be computed through numerical integration.

Consider the general equation of the center line in the ring depicted in FIG. 19 in the x-z plane of the body frame with principal axes of length a and b:

$$\frac{{p}_{i , x}^{2}}{{a}^{2}} + \frac{{p}_{i , z}^{2}}{{b}^{2}} = 1 \qquad ( 2 )$$

where pᵢ=[p_{i,x}, 0, p_{i,z}]^{T} denotes the body-frame coordinates of a point on the ring. Consider the following change of variables:

$${ξ}_{1} = {r}_{y} {C}_{θ} \\ {ξ}_{2} = {r}_{y} {S}_{θ} \qquad ( 3 )$$

where r_{y} and θ are polar coordinates shown in FIG. 19. S_{θ} and C_{θ} denote sin θ and cos θ. The time-derivative is taken from the equation above and Eq. 2, which yields:

$${\dot{ξ}}_{1} = {\dot{r}}_{y} {C}_{θ} - {ξ}_{2} \dot{θ} \\ {\dot{ξ}}_{2} = {\dot{r}}_{y} {S}_{θ} + {ξ}_{1} \dot{θ} \\ \frac{{ξ}_{1} {\dot{ξ}}_{1}}{{a}^{2}} - \frac{2 {ξ}_{1}^{2} {u}_{1}}{{a}^{3}} + \frac{{ξ}_{2} {\dot{ξ}}_{2}}{{b}^{2}} - \frac{2 {ξ}_{2}^{2} {u}_{2}}{{b}^{3}} = 0 \qquad ( 4 )$$

where \dot{a}=u₁ and \dot{b}=u₂. The perimeter of the ring is fixed and given by:

$$P = {\int }_{0}^{2 π} \sqrt{{a}^{2} {C}_{θ}^{2} + {b}^{2} {S}_{θ}^{2}} d θ \qquad ( 5 )$$

therefore, the following relationship can be written between \dot{P} and \dot{θ}:

$$\dot{P} = ( \sqrt{{a}^{2} {C}_{θ}^{2} + {b}^{2} {S}_{θ}^{2}} ) \dot{θ} = 0 \qquad ( 6 )$$

This equation constitutes the remaining ordinary differential equations necessary to establish the state-space model for the posture dynamics. By defining ξ₃=r_{y}, ξ₄=θ, ξ₅=a, and ξ₆=b, and Eqs. 2, 3, 4, and 6, the state-space model governing the state vector ξ=[ξ₁, . . . , ξ₆]^{T} is given by:

$$[ \begin{matrix}1 & 0 & - {C}_{{ξ}_{4}} & {ξ}_{2} & 0 & 0 \\ 1 & 0 & - {S}_{{ξ}_{4}} & {ξ}_{1} & 0 & 0 \\ \frac{{ξ}_{1}}{{ξ}_{5}^{2}} & \frac{{ξ}_{2}}{{ξ}_{6}^{2}} & 0 & 0 & 0 & 0 \\ 0 & 0 & 0 & γ ( ξ ) & 0 & 0 \\ 0 & 0 & 0 & 0 & 1 & 0 \\ 0 & 0 & 0 & 0 & 0 & 1\end{matrix} ] [ \begin{matrix}{\dot{ξ}}_{1} \\ {\dot{ξ}}_{2} \\ {\dot{ξ}}_{3} \\ {\dot{ξ}}_{4} \\ {\dot{ξ}}_{5} \\ {\dot{ξ}}_{6}\end{matrix} ] = [ \begin{matrix}0 & 0 \\ 0 & 0 \\ \frac{2 {ξ}_{1}^{2}}{{ξ}_{5}^{3}} & \frac{2 {ξ}_{2}^{2}}{{ξ}_{6}^{3}} \\ 0 & 0 \\ 1 & 0 \\ 0 & 1\end{matrix} ] [ \begin{matrix}{u}_{1} \\ {u}_{2}\end{matrix} ] \\ where \\ γ ( ξ ) = \sqrt{{ξ}_{5}^{2} {C}_{{ξ}_{4}}^{2} + {ξ}_{6}^{2} {S}_{{ξ}_{4}}^{2}} . \qquad ( 7 )$$

The matrix in the left-hand side of Eq. 7 is invertible, and therefore, the normal form \dot{ξ}=f_{ξ}(ξ, u) can be obtained, which is skipped here. Now, it is possible to show that the mass moments of inertia about the body-frame x, y, and z axes, denoted by [symbol] ₓₓ, [symbol] _{yy}, and [symbol] _{zz}, are functions of the hidden state vector ξ.

The mass of the differential element on the ring can be calculated assuming uniform distribution as follows:

$$dm = \frac{m}{P} dP = \frac{m}{P} γ ( ξ ) d {ξ}_{4} \qquad ( 8 )$$

where m is the total mass of the elliptical ring. Thus, the mass moment of inertia around body frame axis can be obtained by:

$$\begin{matrix}{kk}_{} = \frac{m}{P} {\int }_{{ξ}_{4}} {r}_{k}^{2} γ ( ξ ) d {ξ}_{4} , k ∈ \{ x , y , z \} \\ {r}_{x} = {ξ}_{3} {C}_{{ξ}_{4}} \\ {r}_{y} = {ξ}_{3} \\ {r}_{z} = {ξ}_{3} {S}_{{ξ}_{4}}\end{matrix} \qquad ( 9 )$$

In the equation above, the output function y=h_{ξ}(ξ)=[ [symbol] ]^{T} encapsulates the mass moments of inertia. Next, the equations of motion for the tumbling ring are derived using these posture dynamics as follows.

### C. Governing Dynamics for Tumbling Σ_{tbl}

Considering the ring shown in FIG. 19 with imaginary actuators uᵢ along its two principal axes for posture manipulation. The following coordinates frames of reference are defined to describe the motion of ring:
World frame x₀-y₀-z₀;
Contact frame x₁-y₁-z₁ placed at the contact point p_{c}; its z-axis is perpendicular to the ground surface;
Gimbal frame x₂-y₂-z₂ placed at the CoM p_{cm}; it does not spin with the body;
Body frame x_{b}-y_{b}-z_{b} placed at the CoM P_{cm}; it spins with the ring.

The contact frame from the world frame is inclined at an angle α to create an infinite inclined plane. The orientation R_{b}⁰ of the ring (body coordinate x_{b}-y_{b}-z_{b}) is parameterized using roll, pitch, and yaw angles θ, ψ, and ϕ expressed as:

$${R}_{b}^{0} = {R}_{z} ( θ ) {R}_{y} ( ϕ ) {R}_{x} ( ψ ) \qquad ( 10 )$$

The body frame angular velocity vector w_{b}=[w_{b,x}, w_{b,y}, w_{b,z}]^{T} expressed in terms of \dot{θ}, \dot{ψ}, and \dot{ϕ} is given by:

$$\begin{matrix}{ω}_{b , x} = \dot{ψ} sin ( θ ) sin ( ϕ ) + \dot{θ} cos ( ϕ ) \\ {ω}_{b , y} = \dot{ψ} sin ( θ ) cos ( ϕ ) - \dot{θ} sin ( ϕ ) , \\ {ω}_{b , z} = \dot{ψ} cos ( θ ) + \dot{ϕ}\end{matrix} \qquad ( 11 )$$

From Σₚₒₛ, the rings principal moment of inertia are given by y₁, y₂ and y₃. The angular momentum of the ring about p_{cm} is given by H_{b}=y^{T}w_{b}. The radius of rotation is defined as the vector from p_{cm} to p_{c}. Since the ring is pure rolling at the contact point p_{c}, there will be three constraints to consider, including a holonomic (v_{c,z}=0) and two nonholonomic (v_{c,x}=0) and (v_{c,y}=0) constraints, where v_{c} denotes the contact velocity.

The equations of motion can be formulated by resolving the linear and angular momentum balance concerning the ring's CoM. The resulting equations of motion, derived from applying the balance laws alongside the non-integrable constraints, constitute a set of differential equations describing the ring's orientation and the lateral translation of its CoM over time. This system of equations can be expressed in the first-order form \dot{x}=f(x, y)=M⁻¹(x, y)N(x, y) for numerical integration in MATLAB, given by:

$$M ( x , y ) = [ \begin{matrix}{y}_{1} {S}_{θ} & 0 & 0 & \\ 0 & {y}_{2} + {mr}^{2} & 0 & 0 \\ ( {y}_{3} + {mr}^{2} ) {C}_{θ} & 0 & {y}_{3} + {mr}^{2} & \\ & 0 & & I\end{matrix} ] \qquad ( 12 )$$

where 0 and I are the zero and identity block matrices, respectively. The state vector is x=[θ, ψ, ϕ, \dot{θ}, \dot{ψ}, \dot{ϕ}, p_{c,x}, p_{c,y}]^{T} and r denotes the distance to the contact point. The nonlinear vector N is given by:

$$N ( x , y ) = [ \begin{matrix}( {y}_{3} - 2 {y}_{1} ) \dot{ψ} \dot{θ} {C}_{θ} + {y}_{1} \dot{θ} \dot{ϕ} \\ {β}_{1} \\ ( {y}_{3} + 2 {mr}^{2} ) \dot{ψ} \dot{θ} {S}_{θ} \\ \dot{ψ} \\ \dot{θ} \\ \dot{ϕ} \\ {β}_{2} \\ {β}_{3}\end{matrix} ] \qquad ( 13 )$$

where βᵢ are defined below. This concludes the cascade model derivation.

$$\begin{matrix}{β}_{1} = ( {y}_{1} - {y}_{3} - {mr}^{2} ) {\dot{ψ}}^{2} {S}_{θ} {C}_{θ} - ( {y}_{3} + {mr}^{2} ) \dot{ψ} \dot{ϕ} {S}_{θ} - {mgrC}_{θ} \\ {β}_{2} = - r \dot{ψ} {C}_{ψ} {C}_{θ} + r \dot{θ} {S}_{ψ} {S}_{θ} - r \dot{ϕ} {C}_{ψ} \\ {β}_{3} = - r \dot{ψ} {S}_{ψ} {C}_{θ} - r \dot{θ} {C}_{ψ} {S}_{θ} - r \dot{ϕ} {S}_{ψ}\end{matrix}$$

### Controls

To solve this controls problem, i.e., the ring's posture dynamics Σₚₒₛ is recruited to regulate the heading angle in the tumbling dynamics Σ_{tbl}, consider the following cost function given by:

$$J = {‖ θ - {θ}_{d} ‖}_{2} \qquad ( 14 )$$

where θ_{d} is the desired heading angle. The cost function J is governed by the cascade model given by Eq. 1.

Temporal (i.e., tᵢ, i=1, . . . , n, 0≤tᵢ≤t_{f}) discretization of Eq. 1 to obtain the following systems of equations:

$$\begin{matrix}{\dot{x}}_{i} = {f}_{i} ( {x}_{i} , {y}_{i} ) , & i = 1 , … , n , & 0 \leq {t}_{i} \leq {t}_{f}\end{matrix} \qquad ( 15 )$$

where xᵢ embodies the values of the state vector x at i-th discrete time. And, yᵢ embodies the principal mass moment of inertia of the ring at i-th discrete time. fᵢ denotes the governing dynamics of tumbling at i-th discrete time.

All discrete values from xᵢ to yᵢ in the vectors X=[x₁^{T}(t₁), . . . xₙ^{T}(tₙ)]^{T} and Y=[y₁^{T}(t₁), . . . yₙ^{T}(tₙ)]^{T}.

2n boundary conditions are considered at the boundaries of n discrete periods to ensure continuity, given by:

$$\begin{matrix}{r}_{i} ( x ( 0 ) , x ( {t}_{f} ) , {t}_{f} ) = 0 , & i = 1 , … , 2 n\end{matrix} \qquad ( 16 )$$

Since there are three entries in y, three inequality constraints are considered to ensure the principal mass moment of inertia remains bounded. gᵢ is given by:

$$\begin{matrix}{g}_{i} ( x ( {t}_{i} ) , y ( {t}_{i} ) , {t}_{i} ) \geq 0 , & i = 1 , 2 , 3 , & 0 \leq {t}_{i} \leq {t}_{f}\end{matrix} \qquad ( 17 )$$

To approximate the nonlinear dynamics from the tumbling ring, a method based on polynomial interpolations is employed. This method extremely simplifies the computation efforts. Consider the n time intervals, as defined previously and given by:

$$0 = {t}_{1} < {t}_{2} < … < {t}_{n} = {t}_{f} \qquad ( 18 )$$

The states xᵢ and principal mass moment of inertia terms yᵢ from the ring at these discrete times into a single vector denoted by Y and form a decision parameter vector that the optimizer finds at once. Additionally, the final discrete time t_{f} is appended as the last entry of Y so that tumbling speed too is determined by the optimizer:

$$𝒴 = {[ {x}_{1}^{⊤} , … , {x}_{n}^{⊤} , {y}_{1}^{⊤} , … , {y}_{n}^{⊤} , {t}_{f} ]}^{⊤} \qquad ( 19 )$$

The output function yᵢ(tᵢ) at time tᵢ≤tᵢ₊₁ as the linear interpolation function \tilde{y} between yᵢ(tᵢ) and yᵢ₊₁(tᵢ₊₁) given by:

$$\tilde{y} = {y}_{i} ( {t}_{i} ) + \frac{t - {t}_{i}}{{t}_{i + 1} - {t}_{i}} ( {y}_{i + 1} ( {t}_{i + 1} ) - {y}_{i} ( {t}_{i} ) ) \qquad ( 20 )$$

The states of xᵢ(tᵢ) and xᵢ₊₁ (tᵢ₊₁) are also interpolated. However, a nonlinear cubic interpolation is used which is continuously differentiable with \tilde{\dot{x}}(s)=f(x(s), y(s), s) at s=tᵢ and s=tᵢ₊₁.

To obtain \tilde{x}, the following system of equations:

$$\begin{matrix}\begin{matrix}\tilde{x} ( t ) = {\sum }_{k = 0}^{3} {{c}_{k}^{j} ( \frac{t - {t}_{j}}{{h}_{j}} )}^{k} , & {t}_{j} \leq t < t {<}_{j + 1}\end{matrix} , \\ {c}_{0}^{j} = x ( {t}_{j} ) , \\ {c}_{1}^{j} = {h}_{j} {f}_{j} , \\ {c}_{2}^{j} = - 3 x ( {t}_{j} ) - 2 {h}_{j} {f}_{j} + 3 x ( {t}_{j + 1} ) - {h}_{j} {f}_{j + 1} , \\ {c}_{2}^{j} = 2 x ( {t}_{j} ) + {h}_{j} {f}_{j} - 2 x ( {t}_{j + 1} ) + {h}_{j} {f}_{j + 1} , \\ \begin{matrix}where {f}_{j} := f ( x ( {t}_{j} ) , y ( {t}_{j} ) ) , & {h}_{j} := {t}_{j + 1} - {t}_{j} .\end{matrix}\end{matrix} \qquad ( 21 )$$

The interpolation function \tilde{x} utilized for x needs to fulfill the continuity at discrete points and at the midpoint of sample times. By examining Eq. 21, it is evident that the derivative terms at the boundaries tᵢ and tᵢ+1 are satisfied. Hence, the only remaining constraints in the nonlinear programming problem are the collocation constraints at the midpoint of tᵢ−tᵢ+1 time intervals, the inequality constraints at tᵢ, and the constraints at t₁ and t_{f}, all of which are included in the optimization process.

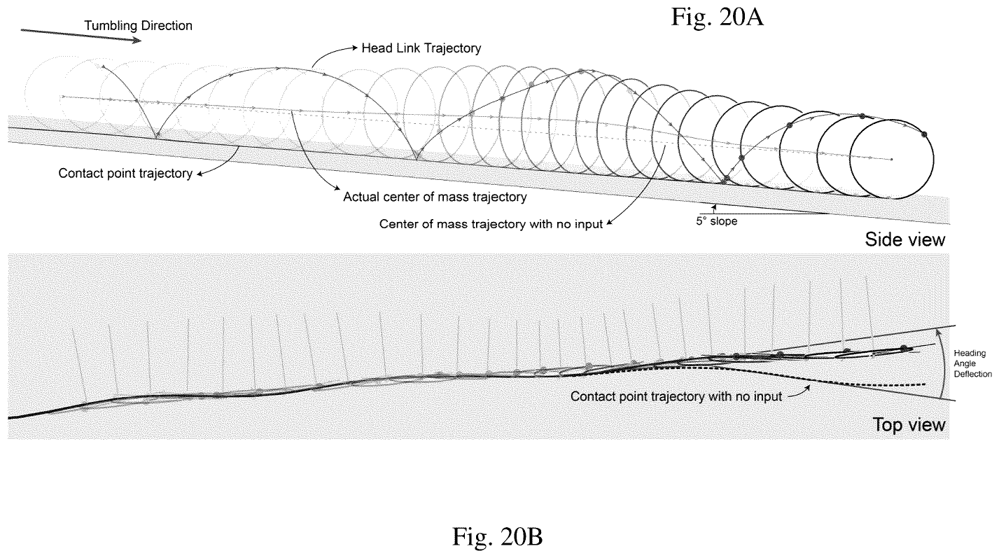

FIG. 20A illustrates the MATLAB simulation of the reduced order model of the robot rolling down a 5° incline with control input applied to change the length of the principle axes of the elliptical ring. FIG. 20B shows the change in the path of tumbling as an impulse is applied to the axes lengths.

Embodiments of the present disclosure were implemented in MATLAB to simulate the robot's behavior. The simulation began with the robot positioned on an infinite plane inclined at 5° about the inertial y axis with zero heading and pitch angles such that the direction of rolling is along the inertial x axis. Initial rolling and pitching velocities were set to 2π rad/s and 0.5 rad/s, respectively. After 2 seconds, an impulse was applied to alter the tumbling trajectory. FIGS. 20A-B depicts the simulation setup and showcases snapshots of the robot changing direction upon receiving the input.

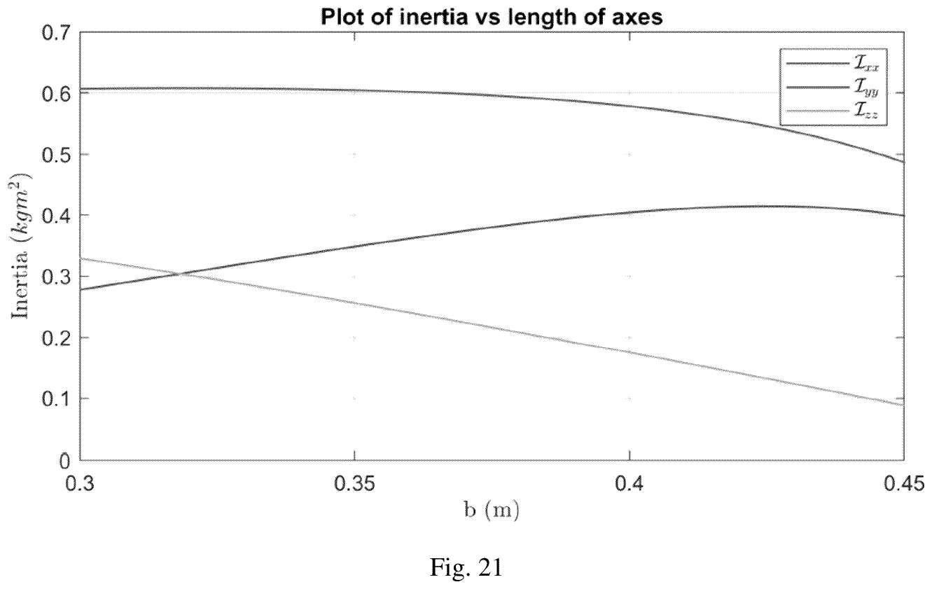

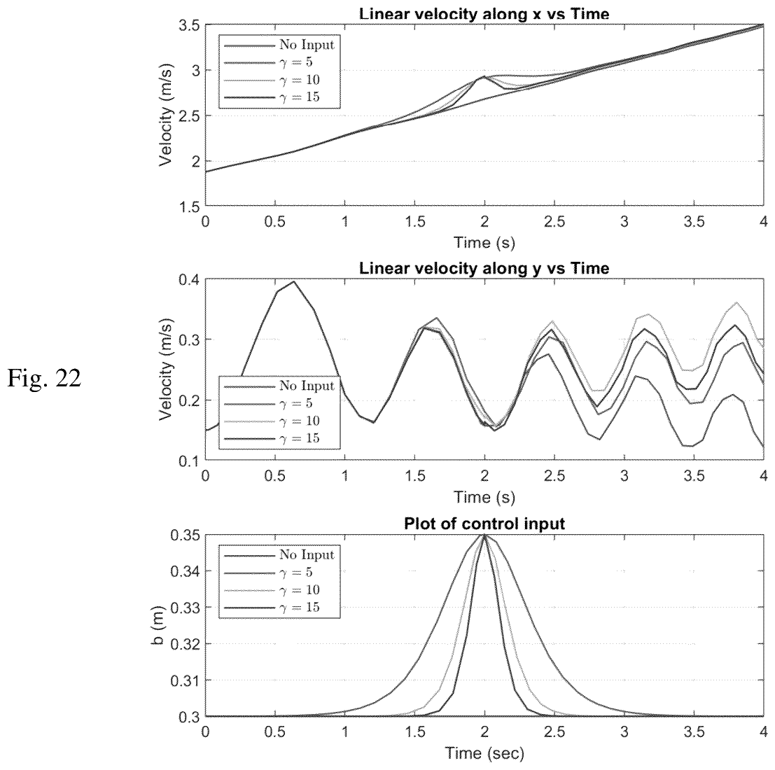

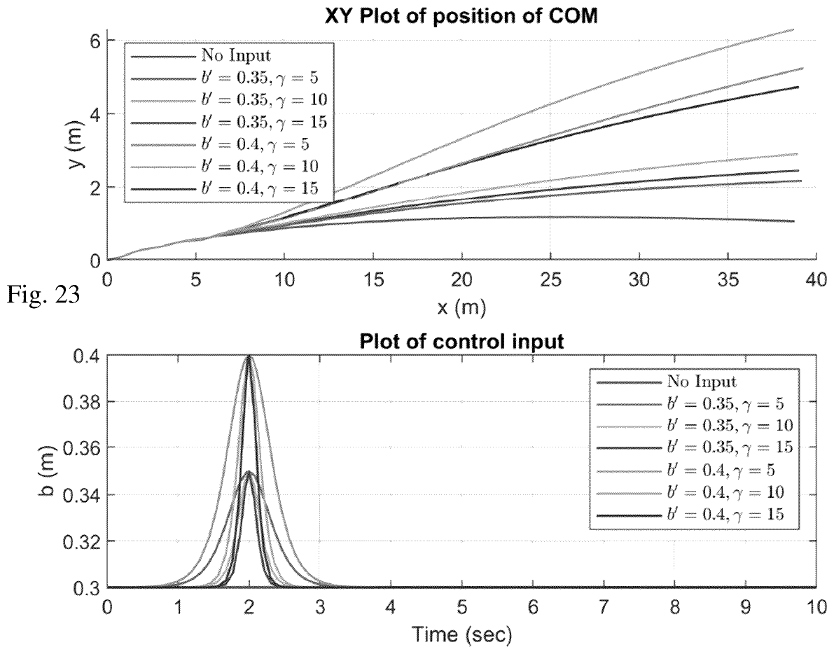

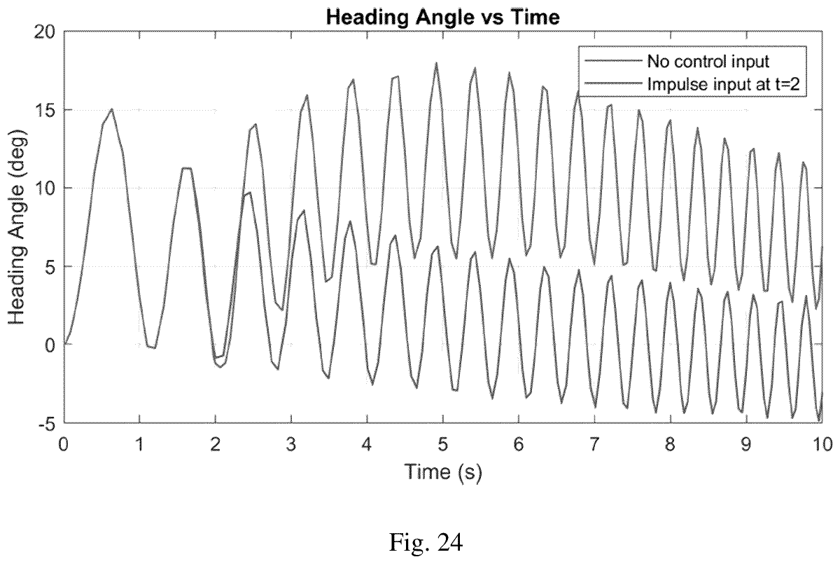

The applied input is an impulse signal to the length of the ellipse's vertical principle axis b. The length of the horizontal principle axis a is dynamically calculated based on a fixed perimeter of 2 m, matching the length of the actual robot. The impulse signal is of the form of the form:

$$b ( t ) = 4 {b}^{′} σ ( γ ( t - {t}_{0} ) ) ( 1 - σ ( γ ( t - {t}_{0} ) ) ) + {b}_{0 \vert}$$

where σ is the Sigmoid function parameterized by variables b′, to and γ representing the amplitude, time and sharpness of the impulse peak respectively, and b₀ refers to the zero input length of the axis b. FIG. 21 shows how the inertia of the tumbling structure varies as the axes lengths are changed, which contributes to the change in rolling dynamics during tumbling. FIG. 22 shows the response of the tumbling dynamics to various impulse inputs. The linear velocity along x increases and decreases with the input, and lateral velocity along y increases as the heading is changed by the impulse. FIG. 23 shows the xy plot of the center of mass of the robot as it tumbles, with the path changing as impulses of various amplitudes and sharpness are applied. The graph shows sharper impulses with higher amplitudes producing a larger deviation from the nominal trajectory with no control inputs applied. FIG. 24 shows the corresponding change in heading angle for an input impulse at t₀=2, with b′=0.35 and γ=10.

### Motion Optimization

The dynamics governing the motion of the COBRA snake robot, possessing 11 body joints, are encapsulated in the following equations of motion:

$$\begin{matrix}M ( q ) \dot{u} - h ( q , u , τ ) = {\sum }_{i} {J}_{i}^{⊤} ( q ) {f}_{ext , i} , \\ h ( q , u , τ ) = C ( q , u ) u + G ( q ) + B ( q ) τ\end{matrix} \qquad ( 1 )$$

In this Equation:
The mass-inertia matrix M pertains to a space of dimensionality [symbol] ^{17×17};
The terms encompassing centrifugal, Coriolis, gravity, and actuation (τ) are succinctly represented by h∈ [symbol] ¹⁷;
External forces f_{ext,i} and their respective Jacobians Jᵢ reside in the space [symbol] ^{3×17}.

For clarity and conciseness, details regarding the specific generalized coordinates and velocities of COBRA are omitted.

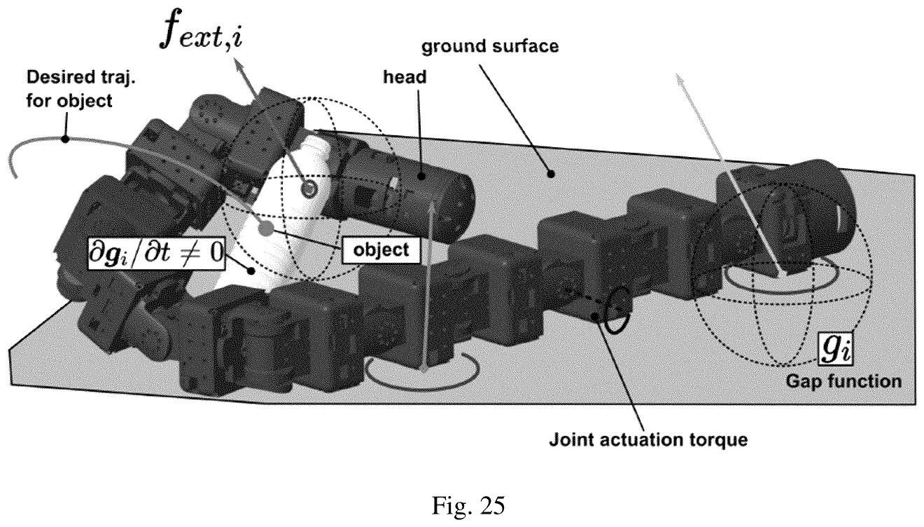

In the object manipulation problem under consideration and shown in FIG. 25, the external forces originate exclusively from active unilateral constraints, e.g., contact forces between the ground surface and the robot or between a movable object and the robot. This assumption conveniently establishes a complementarity relationship (i.e., slackness, where the product of two variables including force and displacement in the presence of holonomic constraints is zero) between the separation gᵢ (the gap between the body, terrain, and object) and the force exerted by a hard unilateral contact.

The concept of normal cone inclusion on the displacements, velocities, and acceleration levels allows for the expression:

$$\begin{matrix}- {g}_{i} ∈ \partial {Ψ}_{i} ( {f}_{ext , i} ) ≡ ( {f}_{ext , i} ) \\ - {\dot{g}}_{i} ∈ \partial {Ψ}_{i} ( {f}_{ext , i} ) ≡ ( {f}_{ext , i} ) \\ - {\ddot{g}}_{i} ∈ \partial {Ψ}_{i} ( {f}_{ext , i} ) ≡ ( {f}_{ext , i} )\end{matrix} \qquad ( 2 )$$

where Ψᵢ(·) denotes the indicator function. The gap function gᵢ is defined such that its total time derivative yields the relative constraint velocity ġᵢ=Wᵢ^{T}u+ζᵢ, where

$${W}_{i} = {W}_{i} ( q , t ) = {( \partial {g}_{i} \frac{i}{\partial q} )}^{⊤}$$

and ζᵢ=ζᵢ(q, t)=∂gᵢ/∂t.

Considering the primary objectives of loco-manipulation with COBRA, various conditions of the normal cone inclusion are examined as described in Eq. 2. In scenarios where non-impulsive unilateral contact forces are employed to manipulate rigid objects (e.g., the box shown in FIG. 25) relative to the world, ∂gᵢ/∂t≠0. This factor holds significant importance in motion planning and is enforced during optimization.

The total time derivative of the relative constraint velocity yields the relative constraint accelerations \dot{\ddot{g}}ₗ=Wᵢ^{T}u+ζᵢ, where ζᵢ=ζᵢ(q, t, u). A geometric constraint on the acceleration level is described such that the initial conditions are fulfilled on velocity and displacement levels:

$$\begin{matrix}{g}_{i} ( q , t ) = 0 , \\ {\dot{g}}_{i} = {W}_{i}^{⊤} u + {ζ}_{i} = 0 , \\ {\ddot{g}}_{i} = {W}_{i}^{⊤} \dot{u} + {\hat{ζ}}_{i} = 0 , \\ {\dot{g}}_{i} = ( {q}_{0} , {u}_{0} , {t}_{0} ) = 0 , \\ \partial {g}_{i} / \partial t \neq 0\end{matrix} \qquad ( 3 )$$

which means the generalized constraint forces must stand perpendicular to the manifolds gᵢ=0, ġᵢ=0 and \ddot{g}ₗ=0. This formulation directly accommodates the integration of friction laws, which naturally pertain to velocity considerations. The contact forces are dissected into normal and tangential components, denoted as f_{ext,i}=[f_{N,i}, f_{T,i}^{T}]^{T}ϵ [symbol] ᵢ.

In this context, the force space [symbol] ᵢ facilitate the specification of non-negative normal forces ( [symbol] ₀⁺) and tangential forces adhering to Coulomb friction {f_{T,i}ϵ [symbol] ², ∥f_{T,i}∥<μ|f_{N,i}|}, with μ representing the friction coefficient.

The underlying rationale behind this approach is that while the force remains confined within the interior of its designated subspace, the contact velocity remains constrained to zero. Conversely, non-zero gap velocities only arise when the forces reach the boundary of their permissible set, indicating either a zero normal force or the maximum friction force opposing the direction of motion.

To proceed in the loco-manipulation problem considered here, it proves advantageous to reconfigure Eq. 1 into local contact coordinates (task space). This can be accomplished by recognizing the relationship:

$$\dot{g} = {J}_{c} u , \qquad ( 4 )$$

where g and J_{c} represent the stacked contact separations and Jacobians, respectively. By differentiating Eq. 4 with respect to time and substituting Eq. 1, the below is obtained:

$$\ddot{g} = {J}_{c} {M}^{- 1} {J}_{c}^{⊤} {f}_{ext} + {\dot{J}}_{c} u + {J}_{c} {M}^{- 1} h , \qquad ( 5 )$$

where G=J_{c}M⁻¹J_{c}^{T}—the Delassus matrix—signifies the apparent inverse inertia at the contact points, and c=\dot{J}_{c}u+J_{c}M⁻¹h encapsulates all terms independent of the stacked external forces fₑₓₜ. At this juncture, the principle of least action asserts that the contact forces are determined by the solution of the constrained optimization problem:

$$\{ \begin{matrix}{minimize}_{\{ {f}_{ext , i} , u \}} \frac{1}{2} {f}_{ext}^{⊤} {Gf}_{ext} + {f}_{ext}^{⊤} c \\ s . t . \\ ( 1 ) M ( q ) u - h ( q , u , τ ) - {\sum }_{i} {J}_{i}^{⊤} ( q ) {f}_{ext , i} = 0 \\ ( 2 ) ‖ q ‖ \leq {q}_{ma x} \\ ( 3 ) ‖ τ ‖ \leq {τ}_{ma x}\end{matrix} \qquad ( 6 )$$

where qₘₐₓ and τₘₐₓ denote maximum joint movements, and actuation torques, respectively. In the above optimization problem, (1), (2), and (3) enforce dynamics agreement, kinematics restrictions, and actuation saturations, respectively. Next, a time-stepping methodology facilitates the integration of system dynamics across a time interval Δt while internally addressing the resolution of contact forces. The shooting method is used to find optimal u_{ref} for minimized joint torques τ such that generalized contact forces fₑₓₜ stand orthogonal to gap functions and their derivative.

### Simulation Setup

A high fidelity simulation has been created using the MATLAB Simulink Multibody Toolbox. Each link is modeled as a rigid body weighing 0.5 kg with inertia matrices derived automatically by MATLAB from the geometry assuming homogeneous mass distribution. The inertia tensor for each of the ten identical body links is (Iₓₓ=7.167×10⁻⁴ I_{yy}=8.704×10⁻⁴, I_{zz}=8.626×10⁻⁴ kgm²), and the inertia tensors for the head and tail modules are (Iₓₓ−4.4562×10⁻⁴, I_{yy}=1.710×10⁻³, I_{zz}=1.793×10⁻³ kgm²) and (Iₓₓ=8.182×10⁻⁴, I_{yy}=1.141×10⁻³, I_{zz}=1.109×10⁻³ kgm²) along the primary axes. The links are connected through a position controlled revolute joint with axis and range of motion mimicking the real robot. The object being manipulated is modeled as a solid box of weight 0.5 kg. The normal forces for all contact interactions between robot links, ground surface and object are modeled using a smooth spring-damper model with spring stiffness 1×10⁻⁴ N/m and damping coefficient 1×10³ Ns/m. Friction forces are modeled using a smooth stick-slip model with coefficient of static friction of 1.3, coefficient of dynamic friction of 1.0 and critical velocity 1×10⁻³ m/s. The dynamics are solved using MATLAB's ode45 with a fixed timestep of 1×10⁻⁴ seconds.

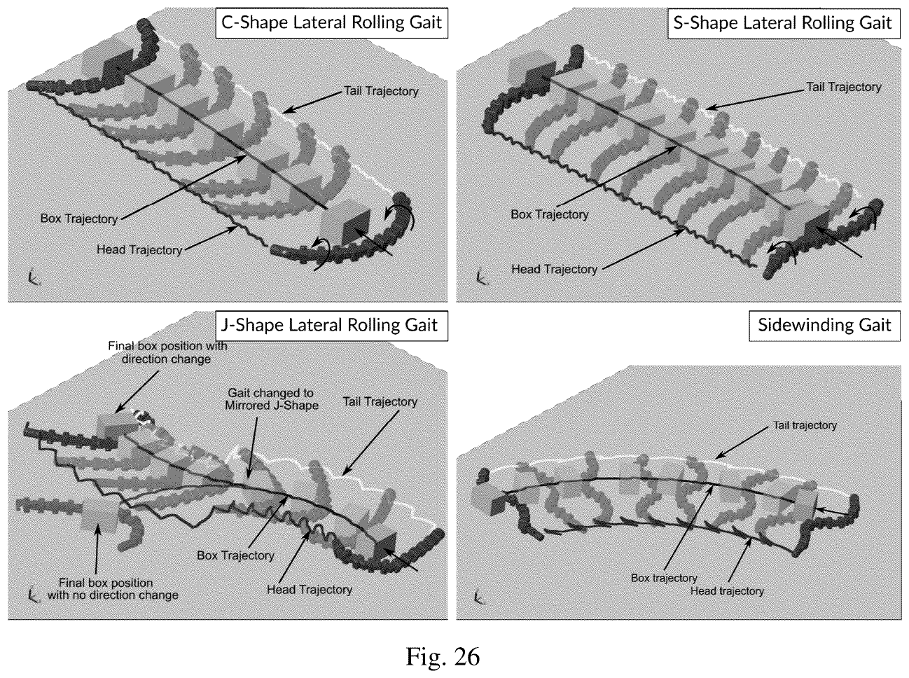

FIG. 26 illustrates a series of gait movements as modeled in MATLAB. The J-shape gait is an asymmetric variation of the C-gait, which allows changing the direction of movement of the box by mirroring the gait.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A robot comprising:
a body comprising a scalable joint module having:
a housing including an actuator within the housing powered by a voltage regulator mounted to the housing and defining a female connector cavity of the housing;
a first plurality of axial thrust roller bearings on the housing and a second plurality of axial thrust roller bearings on an opposite side of the housing, wherein each of the first and second plurality of axial thrust roller bearings are sandwiched between two washers;
a male connector opposite from the female connector cavity; and
a head module coupled to the body, containing an onboard computing system controlling the movement of the lunar exploration robot, and an actuated latching mechanism; and
a tail module coupled to the body, wherein the tail module defines a cavity configured for the actuated latching mechanism of the head module to enter, to thereby couple the head and tail modules.

2. The robot of claim 1, wherein the body comprises a plurality of scalable joint modules linearly arranged.

3. The robot of claim 2, wherein the actuator of each scalable joint module is daisy chained to the actuator before and the actuator behind the scalable joint module, with at least one cable tethering a daisy chained set of actuators to the onboard computing system in the head module.

4. The robot of claim 3, wherein the at least one cable transfers data from each actuator to the onboard computing system.

5. The robot of claim 1, wherein each scalable joint module of the plurality of scalable joint modules further comprises a battery, the battery contained within a pocket defined by the housing.

6. The robot of claim 1, wherein the body is configured to move by sidewinding and by tumbling, wherein movement is controlled by the onboard computing system.

7. The robot of claim 1, wherein a subset of the at least one scalable joint module has an axis of rotation in a vertical direction.

8. The robot of claim 1, wherein a subset of the at least one scalable joint modules has an axis of rotation in a horizontal direction.

9. The robot of claim 1, wherein the robot is configured to form a closed shape when the head module is latched to the tail module.

10. The robot of claim 9, wherein the closed shape is a hexagon.

11. The robot of claim 1, wherein the latching mechanism of the head module comprises a central driving gear and a plurality of latching fins concentric with the head module.

12. The robot of claim 11, wherein the cavity of the tail module defines a plurality of cutouts equal to the number of latching fins on the head module, thereby preventing the head module from moving while latched into the tail module.
